(19) United States
(12) Patent Application Publication
(10) Pub. No.: US 2026/0285334 A1
(43) Pub. Date: Sep. 24, 2026

(54) VERIFICATION AND VALIDATION OF VEHICLE DATA

(71) Applicant: International Business Machines Corporation, Armonk, NY (US)

(72) Inventors: Zhuo Zhao, Beijing (CN); Na Lv, Changping (CN); Yang Yang, SHANGHAI (CN); Guo Fang Yin, Baoshan Dist (CN); Tsung Che CHIANG, Taichung City (TW)

(21) Appl. No.: 19/087,032

(22) Filed: Mar. 21, 2025

(51) Int. Cl. B60W 50/023

(52) U.S. Cl. CPC B60W 50/023

(57) ABSTRACT

Verification of vehicle data includes receiving first data associated with a vehicle. Further, second data associated with the vehicle is retrieved. The second data include sensor data, historical driving data, and multi-dimensional reference data. A set of attributes are extracted from the first data. The set of attributes are verified based on at least one of dynamic contextual data or the second data. The verification of the set of attributes includes at least one of integrity verification associated with the vehicle, route verification of the vehicle, or alignment verification associated with the vehicle. Additionally, a result is generated based on the verification of the set of attributes.

### BACKGROUND

The disclosure relates to verification and more particularly, to data verification.

Integration of technology in modern vehicles has transformed them from simple modes of transportation to sophisticated, internet-connected devices equipped with features like global positioning system (GPS) navigation, entertainment systems, driver assistance tools, and artificial intelligence (AI) driven insights to enhance overall driving experience by offering convenience, and safety. The increasing presence of sensors and connectivity in vehicles allows manufacturers and service providers to gather vast amounts of data for offering diagnostic, optimization, and personalized services to users.

### SUMMARY

In various embodiments of the disclosure, a computer-implemented method for verification and validation of vehicle data is provided. The computer-implemented method includes receiving, by a computer, first data associated with a vehicle. The first data includes at least one of audio data or a set of image frames. The computer-implemented method further includes retrieving, by the computer, second data associated with the vehicle. The second data includes sensor data, historical driving data, and multi-dimensional reference data. The computer-implemented method further includes extracting, by the computer, a set of attributes from the first data. The computer-implemented method further includes verifying, by the computer, the set of attributes based on at least one of dynamic contextual data or the second data. The verification of the set of attributes includes at least one of integrity verification associated with the vehicle, route verification of the vehicle, or alignment verification associated with the vehicle. The dynamic contextual data includes environmental factors associated with the vehicle. The computer-implemented method further includes generating, by the computer, a result based on the verification of the set of attributes.

In various embodiments of the disclosure, a computer system is described. The computer system includes a processor set, one or more computer-readable storage media, and program instructions stored on the one or more computer-readable storage media. The program instructions executable by the processor set to cause the processor set to perform a method for verification and validation of vehicle data. The program instructions further cause the processor set to receive first data associated with a vehicle. The first data includes at least one of audio data, or a set of image frames. The set of image frames includes one or more objects. The program instructions further cause the processor set to retrieve second data associated with the vehicle. The second data includes sensor data, historical driving data, and multi-dimensional reference data. The program instructions further cause the processor set to extract a set of attributes from the first data. The program instructions further cause the processor set to verify the set of attributes based on at least one of dynamic contextual data or the second data. The verification of the set of attributes includes at least one of integrity verification associated with the vehicle, route verification of the vehicle, or alignment verification associated with the vehicle. The dynamic contextual data includes environmental factors associated with the vehicle. The program instructions further cause the processor set to calculate a score for the set of attributes based on the verification of the set of attributes. The program instructions further cause the processor set to generate a result based on the execution of the verification operation.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for verification and validation of vehicle data, in accordance with an embodiment of the disclosure;

FIG. 2 is a diagram that illustrates an environment for verification and validation of the vehicle data, in accordance with an embodiment of the disclosure;

FIG. 3A is a diagram that illustrates an exemplary framework for verification and validation of the vehicle data, in accordance with an embodiment of the disclosure;

FIG. 3B is a diagram that illustrates exemplary operations for integrity verification and validation of the vehicle data, in accordance with an embodiment of the disclosure;

FIG. 3C is a diagram that illustrates exemplary operations for route verification of the vehicle data, in accordance with an embodiment of the disclosure;

FIG. 3D is a diagram that illustrates exemplary operations for consistency verification of the vehicle data, in accordance with an embodiment of the disclosure;

FIG. 3E is a diagram that illustrates exemplary operations for alignment verification of the vehicle data, in accordance with an embodiment of the disclosure;

FIG. 4A is a diagram that illustrates a first exemplary scenario for the consistency verification and validation of the vehicle data, in accordance with an embodiment of the disclosure;

FIG. 4B is a diagram that illustrates a second exemplary scenario for the consistency verification and validation of the vehicle data, in accordance with an embodiment of the disclosure;

FIG. 4C is a diagram that illustrates a third exemplary scenario for the consistency verification and validation of the vehicle data, in accordance with an embodiment of the disclosure;

FIG. 4D is a diagram that illustrates a fourth exemplary scenario for the consistency verification and validation of the vehicle data, in accordance with an embodiment of the disclosure;

FIG. 5A and FIG. 5B are diagrams that collectively illustrate an exemplary scenario for alignment verification and validation of the vehicle data, in accordance with an embodiment of the disclosure; and

FIG. 6 is a diagram that illustrates a flowchart of an exemplary method for verification and validation of the vehicle data, in accordance with an embodiment of the disclosure.

### DETAILED DESCRIPTION

Integration of advanced technology in modern vehicles has transitioned them from basic modes of transportation to sophisticated, internet-connected systems. These vehicles are now equipped with connected features like GPS navigation, entertainment systems, driver assistance tools, and AI driven insights, all designed to enhance driving experience by providing improved convenience and safety. However, these connected features also raise concerns about data privacy and security as the vehicles collect a wide range of data, from driving habits to personal details of users driving the vehicles. These personal details may encompass details such as facial expressions and sensitive information about when, where, and how the users drive the vehicles. Additionally, the collected data can be manipulated or falsified, thereby undermining the integrity of the collected data and posing a challenge for verification of the collected data.

Conventional systems attempt to address data verification challenges in connected vehicles through methods like encryption, digital signatures, and secure storage. Encryption ensures that the data is protected during transmission, preventing unauthorized access but does not verify authenticity or integrity of the data. A digital signature confirms a source of the data but cannot detect whether the data was manipulated before being signed. Further, the secure storage ensures the immutability of the data but often struggles with scalability, high computation cost, and susceptibility to internal data manipulation. Additionally, the conventional systems analyze metadata associated with the data (e.g., video data), such as timestamps, GPS coordinates, and the like. The conventional systems aim to only identify inconsistencies between the metadata and the data. However, this approach is limited by reliance on the accuracy of the metadata and can be unreliable as the metadata can be manipulated.

To address these issues, a system that can perform verification of vehicle data (e.g., the data associated with the vehicle) is disclosed. Such a system leverages machine learning models to extract a set of attributes associated with first data associated with a vehicle. Further, the system retrieves second data associated with the vehicle. The system further verifies the set of attributes with at least one of dynamic contextual data (e.g., environmental factors associated with the vehicle), or the second data. The verification of the set of attributes includes at least one of integrity verification associated with the vehicle, route verification of the vehicle, or alignment verification associated with the vehicle. The system further generates a result based on the verification of the set of attributes.

The disclosed system combines integrity verification, route verification, alignment verification, and consistency verification for the set of attributes. Thus, the disclosed system utilizes a multi-layered approach that ensures improved reliability and accuracy for the verification of the set of attributes. The reliability and accuracy of the disclosed system are improved by cross-referencing multiple data points such as sensor data, historical driving data, and multi-dimensional reference data associated with the vehicle and ensuring that discrepancies are flagged and evaluated from different angles. Further, by combining various verification techniques, the disclosed system enhances the depth of the verification process, thereby reducing the risk of overlooked manipulations and false positives.

In various embodiments of the disclosure, a computer-implemented method for verification and validation of vehicle data is provided. The computer-implemented method includes receiving, by a computer, first data associated with a vehicle. The first data includes at least one of audio data or a set of image frames. The computer-implemented method further includes retrieving, by the computer, second data associated with the vehicle. The second data includes sensor data, historical driving data, and multi-dimensional reference data. The computer-implemented method further includes extracting, by the computer, a set of attributes from the first data. The computer-implemented method further includes verifying, by the computer, the set of attributes based on at least one of dynamic contextual data or the second data. The verification of the set of attributes includes at least one of integrity verification associated with the vehicle, route verification of the vehicle, or alignment verification associated with the vehicle. The dynamic contextual data includes environmental factors associated with the vehicle. The computer-implemented method further includes generating, by the computer, a result based on the verification of the set of attributes. Therefore, the disclosed computer-implemented method provides verification of the first data that can potentially correspond to tampered data associated with the vehicle based on one or more verification techniques, thereby improving the reliability of the computer. Thus, the disclosed computer-implemented method can be implemented as a verification method by various entities to verify the authenticity of the first data and reduce the risk of false positive results.

In various embodiments of the disclosure, the computer-implemented method further includes calculating, by the computer, a score for the set of attributes based on the verification of the set of attributes. The computer-implemented method further includes generating, by the computer, the result based on the calculated score for the set of attributes. The computer-implemented method further includes classifying, by the computer, the first data as one of authentic data or tampered data based on the generated result. Therefore, the disclosed computer-implemented method enhances decision-making accuracy by calculating the score for the set of attributes based on the verification of the set of attributes. This ensures a quantifiable and objective evaluation, thereby enabling consistent and reliable results based on the verification of the first data (the set of attributes).

In various embodiments of the disclosure, the set of image frames includes one or more objects. The disclosed computer-implemented method includes identifying the one or more objects from the set of image frames. The disclosed computer-implemented method includes verifying the set of attributes associated with the one or more objects based on at least one of the dynamic contextual data or the second data. Therefore, the disclosed computer-implemented method ensures reliable validation by verifying the set of attributes based on at least one of the dynamic contextual data or the second data. The dynamic contextual data includes environmental factors associated with the vehicle such as principles of light, shadow dynamics data, the object interaction data, or the human motion dynamics data. Thus, by introducing the dynamic contextual data for the verification of the set of attributes, the system ensures precision and robustness of the verification.

In various embodiments of the disclosure, the set of attributes includes at least one of a source of light associated with the one or more objects, shadows associated with the one or more objects, or interactions associated with the one or more objects. The computer-implemented method further includes verifying, by the computer, an integrity of the set of attributes based on the dynamic contextual data. Therefore, the disclosed computer-implemented method ensures that the set of attributes is verified based on the dynamic contextual data that includes the environmental factors associated with the vehicle. By verifying the set of attributes based on the dynamic contextual data, the computer can detect subtle manipulation or inconsistencies, thereby ensuring a higher degree of reliability compared to conventional solutions.

In various embodiments of the disclosure, the verification of the integrity of the set of attributes includes physics based verification, and biometric verification. The disclosed computer-implemented method includes verifying the set of attributes based on physics based verification that includes verifying light associated with the one or more objects and shadows associated with the one or more objects. The physics-based verification may include determining whether the set of attributes adheres to established physical principles. This includes evaluating factors such as light behavior, shadow projections, object dynamics, and the like, to determine whether the set of attributes aligns with real-world physical laws. The physics based verification ensures that visual characteristics such as light distribution and shadow consistency are physically plausible, thereby increasing the reliability of the integrity verification. Additionally, the biometric verification ensures that human activity captured in the first data aligns with natural movement patterns.

In various embodiments of the disclosure, the set of attributes includes first metadata associated with the set of image frames. The computer-implemented method further includes verifying, by the computer, an integrity of the set of attributes based on the sensor data. Therefore, the disclosed computer-implemented method ensures that the integrity verification of the set of attributes based on metadata associated with the set of image frames is robust. Thus, the disclosed computer-implemented method identifies inconsistencies and provides a reliable mechanism for detecting data tampering or data anomalies.

In various embodiments of the disclosure, the sensor data includes second metadata associated with the vehicle. The verification of the integrity of the set of attributes includes metadata verification of the set of attributes and the sensor data. Therefore, the disclosed computer-implemented method ensures enhanced reliability of the verification by cross-referencing the first metadata and the second metadata for verifying the set of attributes for identification of data manipulation.

In various embodiments of the disclosure, the set of attributes includes at least one of an availability of the one or more objects, spatial relations associated with the one or more objects, or an orientation associated with the one or more objects. The computer-implemented method further includes determining, by the computer, a first field of view associated with the vehicle based on the multi-dimensional reference data. The computer-implemented method further includes determining, by the computer, a second field of view associated with the vehicle based on the set of attributes. The computer-implemented method further includes verifying, by the computer, an alignment factor associated with an alignment between the first field of view and the second field of view. The multi-dimensional reference data corresponds to a three-dimensional (3D) model associated with the vehicle that includes vehicle interior and hardware configuration settings that may be provided by the original equipment manufacturer (OEM) or the vehicle manufacturer. Therefore, the disclosed computer-implemented method ensures consistency of alignment between the first field of view and the second field of view, thereby providing robust detection of inconsistencies or discrepancies between the set of attributes and the multi-dimensional reference data.

In various embodiments of the disclosure, the multi-dimensional reference data includes a three-dimensional model associated with the vehicle. The disclosed computer-implemented method includes determining, the first field of view associated with the vehicle based on the three-dimensional model. Therefore, the disclosed computer-implemented method ensures that the first field of view accurately reflects various aspects of the vehicle such as spatial relations associated with the one or more objects, or an orientation associated with the one or more objects. Further, the alignment verification ensures that the first field of view aligns with the second field of view, thereby ensuring a higher degree of reliability and robustness compared to conventional solutions.

In various embodiments of the disclosure, the verification of the set of attributes further includes consistency verification. The set of attributes includes at least one of geographical indicators, environmental indicators, infrastructural indicators, atmospheric indicators, or human activity indicators. The computer-implemented method further includes verifying, by the computer, a consistency of the set of attributes based on the historical driving data. Therefore, the disclosed computer-implemented method ensures that the set of attributes of the first data aligns with expected patterns and conditions based on the historical driving data, thereby providing an additional layer of verification. By cross-referencing the set of attributes with the historical driving data, the disclosed computer-implemented method can identify data anomalies, thereby ensuring a higher degree of reliability and robustness compared to conventional solutions.

In various embodiments of the disclosure, the computer-implemented method further includes identifying, by the computer, one or more identifiers associated with the historical driving data. The computer-implemented method further includes assigning, by the computer, a set of weights to the one or more identifiers. The computer-implemented method further includes determining, by the computer, a set of ratings associated with the set of attributes based on the verification of the consistency of the set of attributes. The computer-implemented method further includes calculating, by the computer, a consistency parameter for the set of attributes based on the set of weights and the set of ratings. The computer-implemented method further includes generating, by the computer, the result based on the calculated consistency parameter. Therefore, the disclosed computer-implemented method provides an accurate and quantifiable assessment of the consistency of the set of attributes, thereby improving the reliability of the verification process by providing an additional layer of verification.

In various embodiments of the disclosure, the set of attributes includes location metadata associated with the audio data or the set of image frames. The computer-implemented method further includes verifying, by the computer, first location data of the vehicle associated with the set of attributes based on the sensor data associated with a set of sensors of the vehicle. The sensor data includes second location metadata of the vehicle. Therefore, the disclosed computer-implemented method provides enhanced reliability for the verification by cross-referencing the first location metadata and the second location metadata.

In various embodiments of the disclosure, a computer system is described. The computer system includes a processor set, one or more computer-readable storage media, and program instructions stored on the one or more computer-readable storage media. The program instructions executable by the processor set to cause the processor set to perform a method for verification and validation of vehicle data. The program instructions further cause the processor set to receive first data associated with a vehicle. The first data includes at least one of audio data, or a set of image frames. The set of image frames includes one or more objects. The program instructions further cause the processor set to retrieve second data associated with the vehicle. The second data includes sensor data, historical driving data, and multi-dimensional reference data. The program instructions further cause the processor set to extract a set of attributes from the first data. The program instructions further cause the processor set to verify the set of attributes based on at least one of dynamic contextual data or the second data. The verification of the set of attributes includes at least one of integrity verification associated with the vehicle, route verification of the vehicle, or alignment verification associated with the vehicle. The dynamic contextual data includes environmental factors associated with the vehicle. The program instructions further cause the processor set to calculate a score for the set of attributes based on the verification of the set of attributes. The program instructions further cause the processor set to generate a result based on the execution of the verification operation. The disclosed system provides verification of first data that can potentially correspond to tampered data associated with the vehicle based on one or more verification techniques, thereby improving the reliability of the computer. Thus, the disclosed system can be implemented as a verification system by various entities to verify the authenticity of the first data and reduce the risk of false positive results. Additionally, the disclosed system calculates the score for the set of attributes based on the verification of the set of attributes to enhance decision-making accuracy. This ensures a quantifiable and objective evaluation, thereby enabling consistent and reliable results based on the verification of the first data (the set of attributes).

In various embodiments of the disclosure, the program instructions further cause the processor set to classify the first data as one of authentic data or tampered data based on the generated result. The disclosed system ensures reliable classification of the first data by leveraging the verification (integrity verification associated with the vehicle, route verification of the vehicle, or alignment verification associated with the vehicle).

In various embodiments of the disclosure, the set of attributes includes at least one of a source of light associated with the one or more objects, shadows associated with the one or more objects, or interactions associated with the one or more objects. The program instructions further cause the processor set to verify an integrity of the set of attributes based on the dynamic contextual data. The disclosed system ensures that the set of attributes is verified based on the dynamic contextual data that includes the environmental factors associated with the vehicle. Further, the disclosed system verifies the set of attributes based on the dynamic contextual data to detect subtle manipulation or inconsistencies in the set of attributes, thereby ensuring a higher degree of reliability compared to conventional solutions. The dynamic contextual data includes environmental factors associated with the vehicle such as principles of light, shadow dynamics data, the object interaction data, or the human motion dynamics data. Thus, by introducing the dynamic contextual data for the verification of the set of attributes, the system ensures the precision and robustness of the verification.

In various embodiments of the disclosure, the verification of the integrity of the set of attributes includes physics based verification, and biometric verification. The disclosed system verifies the set of attributes based on physics based verification that includes the verification of the light associated with the one or more objects and the shadows associated with the one or more objects. The physics based verification ensures that visual characteristics such as light distribution and shadow consistency are physically plausible, thereby increasing the reliability of the integrity verification. Additionally, the biometric verification ensures that human activity captured in the first data aligns with natural movement patterns.

In various embodiments of the disclosure, the set of attributes includes first metadata associated with the set of images. The program instructions further cause the processor set to verify an integrity of the set of attributes based on the sensor data. The disclosed system ensures that the integrity verification of the set of attributes based on metadata associated with the set of image frames is robust. Thus, the disclosed system identifies inconsistencies and provides a reliable mechanism for detecting data tampering or data anomalies.

In various embodiments of the disclosure, the sensor data includes second metadata associated with the vehicle. The verification of the integrity includes metadata verification of the set of attributes and the sensor data. Therefore, the disclosed system ensures enhanced reliability of the verification by cross-referencing the first metadata and the second metadata to verify the set of attributes for identification of data manipulation.

In various embodiments of the disclosure, the set of attributes includes at least one of an availability of the one or more objects, spatial relations associated with the one or more objects, or an orientation associated with the one or more objects. The program instructions further cause the processor set to determine a first field of view associated with the vehicle based on the multi-dimensional reference data. The program instructions further cause the processor set to determine a second field of view associated with the vehicle based on the set of attributes. The program instructions further cause the processor set to verify an alignment factor associated with an alignment between the first field of view and the second field of view. The multi-dimensional reference data corresponds to a three-dimensional (3D) model associated with the vehicle that includes vehicle interior and hardware configuration settings that may be provided by the original equipment manufacturer (OEM) or the vehicle manufacturer. Therefore, the disclosed system ensures consistency of alignment between the first field of view and the second field of view, thereby providing robust detection of inconsistencies or discrepancies between the set of attributes and the multi-dimensional reference data.

In various embodiments of the disclosure, a computer-program product is described. The computer-program product includes one or more computer-readable storage media and program instructions stored on the one or more computer-readable storage media to perform operations for verification and validation of vehicle data. The operations include receiving first data associated with a vehicle. The first data includes at least one of audio data, or a set of image frames. The operations further include retrieving second data associated with the vehicle. The second data includes sensor data, historical driving data, and multi-dimensional reference data. The operations further include extracting a set of attributes from the first data. The operations further include verifying the set of attributes based on at least one of dynamic contextual data or the second data. The verification of the set of attributes includes at least one of integrity verification associated with the vehicle, route verification of the vehicle, or alignment verification associated with the vehicle. The dynamic contextual data includes environmental factors associated with the vehicle. The operations further include generating a result based on the verification of the set of attributes. Therefore, the disclosed computer program product provides verification of the first data based on one or more verification techniques, thereby improving the reliability of the computer. Thus, the disclosed computer program product reduces the risk of false positive results and verifies the authenticity of the first data.

Additional technical features and benefits are realized through the various processes of the disclosure. Embodiments and aspects of the disclosure are described in detail herein and are considered a part of the claimed subject matter. For a better understanding, refer to the detailed description and to the drawings.

Various aspects of the disclosure are described by narrative text, flowcharts, block diagrams of computer systems, and/or block diagrams of the machine logic included in computer-program product (CPP) embodiments. With respect to any flowcharts, depending upon the technology involved, the operations can be performed in a different order than what is shown in a given flowchart. For example, again depending upon the technology involved, two operations shown in successive flowchart blocks could be performed in reverse order, as a single integrated operation, concurrently, or in a manner at least partially overlapping in time.

A computer-program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium could be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or additional freely propagating electromagnetic waves, electromagnetic waves propagating through a waveguide, light pulses passing through a fiber optic cable, electrical signals communicated through a wire, and/or additional transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

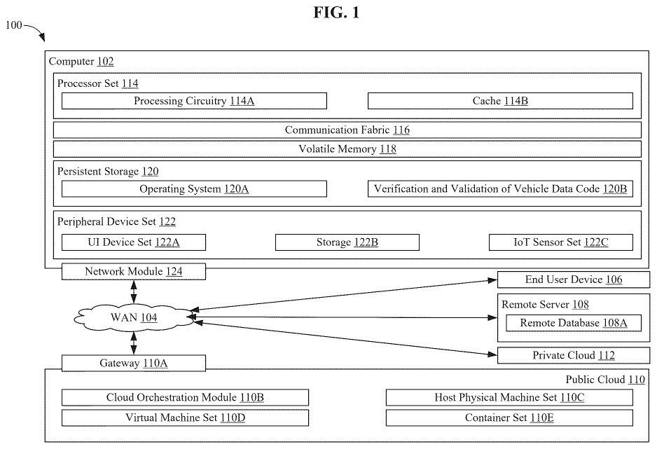

FIG. 1 is a diagram that illustrates a computing environment for verification and validation of vehicle data, in accordance with an embodiment of the disclosure. With reference to FIG. 1, there is shown a computing environment 100 that contains an example of an environment for the execution of at least some of the computer code involved in performing the disclosed methods, such as verification and validation of vehicle data code 120B. In addition to the verification and validation of vehicle data code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the verification and validation of vehicle data code 120B, as identified above), a peripheral device set 122 (including a user interface (UI) device set 122A, a storage 122B, and an Internet of Things (IOT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or additional wearable computer, a mainframe computer, a quantum computer, or any form of a computer or a mobile device now known or to be developed in the future that may be configured for running a program, accessing a network or querying a database, such as a remote database 108A. As is well understood in the art of computer technology, and depending upon the technology, the performance of a computer-implemented method may be distributed among multiple computers and/or between multiple locations. In an embodiment, in this presentation of the computing environment 100, detailed discussion is focused on a single computer, specifically the computer 102, to keep the presentation as simple as possible. The computer 102 may be located in a cloud, even though it is not shown in a cloud in FIG. 1. In alternate embodiment, computer 102 may not be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the additional storage media discussed below. The program instructions, and associated data, are accessed by the processor set 114 to control and direct the performance of the disclosed methods. In computing environment 100, at least some of the instructions for performing the disclosed methods may be stored in the dynamic modification of the verification and validation of vehicle data code 120B in persistent storage 120.

The communication fabric 116 is the signal conduction path that allows the various components of computer 102 to intercommunicate. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not general case unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the verification and validation of vehicle data code 120B typically includes at least some of the computer code involved in performing the disclosed methods.

The peripheral device set 122 includes the set of peripheral devices of computer 102. Data communication connections between the peripheral devices and the additional components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 may have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with one or more computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is a wide area network (for example, the internet) that may be configured for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or alternatively present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by the one or more computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or additional computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer-program running on an ordinary operating system can utilize resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, the private cloud 112 may be disconnected from the internet entirely and only accessible through a local/private network. A hybrid cloud is a composition of multiple clouds of different types (for example, private, community, or public cloud types), often respectively implemented by different vendors. Each cloud of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

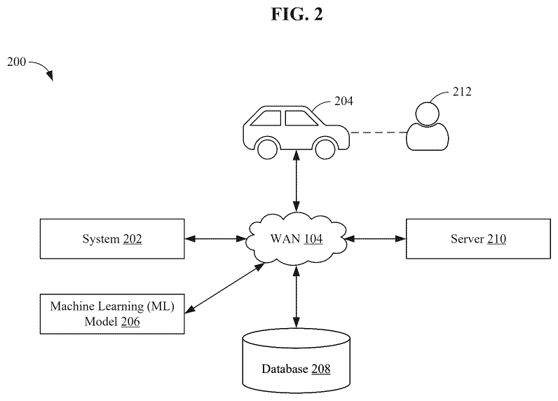

FIG. 2 is a diagram that illustrates an environment for verification and validation of the vehicle data, in accordance with an embodiment of the disclosure. FIG. 2 is explained in conjunction with elements from FIG. 1. With reference to FIG. 2, there is shown a diagram of a network environment 200. The network environment 200 includes a system 202, a vehicle 204, and a machine learning (ML) model 206. The network environment 200 further includes a database 208, a server 210, and a user 212 associated with the vehicle 204. The network environment 200 further includes the WAN 104 of FIG. 1. In an embodiment of the disclosure, the system 202 may be an exemplary embodiment of the computer 102 of FIG. 1.

The system 202 may include suitable logic, circuitry, interfaces, and/or code that may be configured for verification and validation of vehicle data associated with the vehicle 204. The system 202 may be configured to receive first data associated with the vehicle 204. The first data may correspond to audio data or video data (e.g., a set of image frames) associated with the vehicle 204, and is hereinafter referred to as “first vehicle data”. The system 202 may receive the first vehicle data from one or more sources. Examples of the one or more sources may include, law enforcement authorities, insurance companies, regulatory agencies, and the like.

In an embodiment, the first vehicle data may correspond to authentic data or tampered data and is provided to the system 202 for verification. The authentic data may correspond to accurate or unaltered data related to the vehicle 204. Examples of the authentic data may correspond to unaltered data (e.g., video data, audio data, GPS data, and the like) obtained from the vehicle 204. The tampered data may correspond to manipulated or falsified data (e.g., deep fake video data, tampered audio data, and the like) related to the vehicle 204. The first vehicle data may include one or more objects. In an embodiment, when the first vehicle data may correspond to the video data (e.g., set of image frames), the one or more objects may correspond to visual elements or entities captured in the set of image frames such as passengers (e.g., the user 212) present in the vehicle 204, objects (e.g., mobile devices, bags, seatbelts, seat cushions, dashboard figurines, and the like) present in the vehicle 204, road signs, buildings, and additional environmental features visible within the video data. In additional embodiments, when the first vehicle data may correspond to the audio data, the one or more objects may correspond to distinct sound patterns or waveforms within the audio data.

The vehicle 204 may correspond to a car, a truck, a bus, or the like, and may be equipped with a set of sensors to capture and transmit various information to various entities such as car manufacturers, service providers, or regulatory agencies. The set of sensors may include at least one of a positional sensor (e.g., a Global Positioning Sensor), an environmental sensor (e.g., a rain sensor, pressure sensor), a motion sensor, a proximity sensor, an acoustic sensor, and the like. The set of sensors may collect sensor data associated with the vehicle 204. Examples of the sensor data may include GPS data associated with the vehicle 204, environmental data associated with the vehicle 204 (e.g., temperature, pressure, light conditions), audio data (e.g., ambient noise data), and the like. In an embodiment, the vehicle 204 may transmit the sensor data to at least one of the databases 208 or the server 210.

The ML model 206 may be a computational network or a system of artificial neurons, arranged in a plurality of layers, as nodes. The plurality of layers of the ML model 206 may include an input layer, one or more hidden layers, and an output layer. Each layer of the plurality of layers may include one or more nodes (or artificial neurons). Outputs of nodes in the input layer may be coupled to at least one node of the hidden layer(s). Similarly, inputs of each hidden layer may be coupled to outputs of at least one node in one or more layers of the ML model 206. Outputs of each hidden layer may be coupled to inputs of at least one node in one or more layers of the ML model 206. Node(s) in the final layer may receive inputs from at least one hidden layer to output a result. The number of layers and the number of nodes in each layer may be determined from hyper-parameters of the ML model 206. Such hyper-parameters may be set before or while training the ML model 206 on a training dataset.

Each node of the ML model 206 may correspond to a mathematical function (e.g., a sigmoid function or a rectified linear unit) with a set of parameters, tunable during the training of the network. The set of parameters may include, for example, a weight parameter, a regularization parameter, and the like. Each node may use the mathematical function to compute an output based on one or more inputs from nodes in one or more layers (e.g., previous layer(s)) of the ML model 206. Some of the nodes of the ML model 206 may correspond to the same or a different mathematical function.

During the training of the ML model 206, one or more parameters of each node of the ML model 206 may be updated based on whether an output of the final layer for a given input (from the training dataset) matches a correct result based on a loss function for the ML model 206. The above process may be repeated for the same or a different input until a minima of loss function may be achieved, and a training error may be minimized. Several methods for training are known in the art, for example, gradient descent, stochastic gradient descent, batch gradient descent, gradient boost, meta-heuristics, and the like.

The ML model 206 may include electronic data, such as, for example, a software program, code of the software program, libraries, applications, scripts, or additional logic or instructions for execution by a processing device, such as the processor set 114. The ML model 206 may include code and routines configured to enable a computing device, such as the system 202, to perform one or more operations. Additionally, or alternatively, the ML model 206 may be implemented using hardware including a processor, a microprocessor (e.g., to perform or control the performance of one or more operations), a field-programmable gate array (FPGA), or an application-specific integrated circuit (ASIC). Alternatively, in some embodiments, the ML model 206 may be implemented using a combination of hardware and software. Although in FIG. 2, the ML model 206 is shown as a separate entity from the system 202, the disclosure is not so limited. Accordingly, in some embodiments, the ML model 206 may be integrated within the system 202, without deviation from the scope of the disclosure. In an embodiment, the ML model 206 may be stored in the server 210. Examples of the ML model 206 may include, but are not limited to, a deep neural network (DNN), a convolutional neural network (CNN), a CNN-recurrent neural network (CNN-RNN), an artificial neural network (ANN), a fully connected neural network, and/or a combination of such networks.

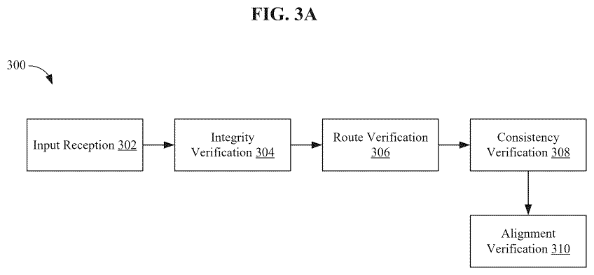

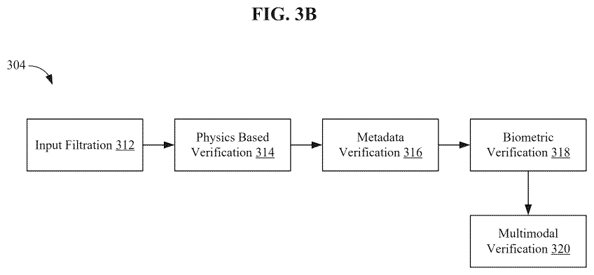

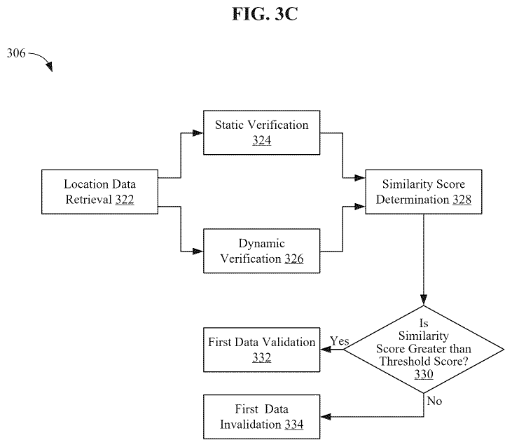

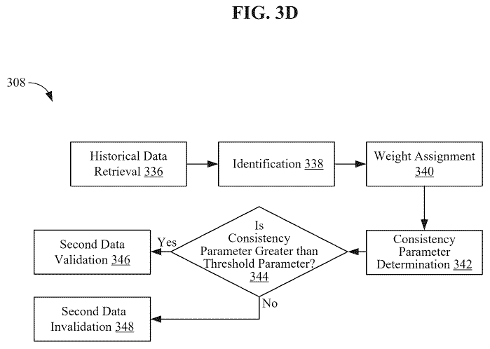

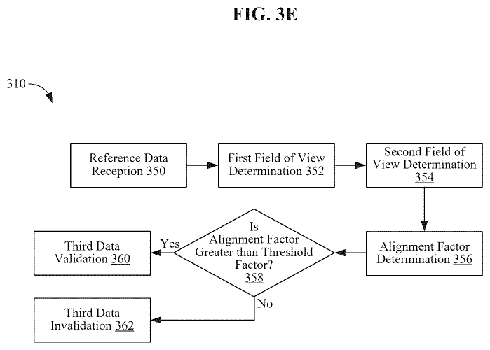

In additional embodiments, the ML model 206 may be a sophisticated piece of software that leverages natural language processing (NLP) and machine learning processes such as optical character recognition (OCR) to understand, generate, and manipulate human language. For example, the ML model 206 may extract textual data from the images that include text, or from scanned documents, photographs, or video frames. Further, the ML model 206 may correspond to a language model or a large language model (LLM) model that is specifically designed for tasks related to language understanding and generation on a large scale such as understanding extracted textual information. In an embodiment, the ML model 206 may be configured to extract the set of attributes from the first vehicle data to analyze various features and patterns within the first vehicle data. The ML model 206 may use techniques such as object detection, feature mapping, and motion analysis to extract the set of attributes. For example, the ML model 206 may detect presence of the one or more objects in the first vehicle data, orientations of the one or more objects in the first vehicle data, and movement of the one or more objects in the first vehicle data. Additionally, the ML model 206 may determine interactions between the one or more objects such as proximity, synchronized movements, collision events, and the like. Thus, the ML model 206 builds a structured representation of the first vehicle data, thereby assisting the system 202 in the classification of the first vehicle data. Details about the ML model 206 are provided, for example in FIG. 2, FIG. 3A, FIG. 3B, FIG. 3D, and FIG. 3E.

The database 208 may correspond to an organized collection of data that may be stored and accessed electronically from a computer system (such as the system 202). In an embodiment, the database 208 may store the sensor data received from the vehicle 204. Additionally, the sensor data collected and stored overtime may correspond to historical driving data associated with the vehicle 204. Further, the database 208 may receive multi-dimensional reference data associated with the vehicle 204. The structure of the database 208 typically involves tables, records, and fields that can be managed through various database management systems (DBMS). Examples of the database 208 may include, but are not limited to, a relational database, a Non-Structured Query Language (NoSQL) database, a hierarchical database, a network database, a transactional database, a data warehouse, a distributed database, or the like.

The server 210 may include suitable logic, circuitry, interfaces, and/or code that may be configured to receive the sensor data from the vehicle 204. Upon receiving the sensor data, the server 210 may be further configured to store the sensor data. Additionally, the sensor data collected and stored overtime may correspond to historical driving data associated with the vehicle 204. In an embodiment, the server 210 may be configured to store the ML model 206. The server 210 may be implemented as a cloud server and may execute operations through web applications, cloud applications, HTTP requests, repository operations, file transfer, and the like. Additional example implementations of the server 210 may include, but are not limited to, a database server, a file server, a web server, a media server, an application server, a mainframe server, or a cloud computing server.

In an embodiment of the disclosure, the server 210 may be implemented as a plurality of distributed cloud-based resources by use of several technologies that are well known to those ordinarily skilled in the art. A person with ordinary skill in the art will understand that the scope of the disclosure may not be limited to the implementation of the server 210 and the system 202 as two separate entities. In certain embodiments, the functionalities of the server 210 can be incorporated in its entirety or at least partially in the system 202, without a departure from the scope of the disclosure.

The user 212 may be an occupant of the vehicle 204 such that the first vehicle data may be associated with the user 212 and the vehicle 204. Additionally, the first vehicle data may be further associated with one or more users associated with the user 212 such that the one or more users may also be the occupants of the vehicle 204. For example, the first vehicle data may correspond to a video of a cabin of the vehicle 204 such that the video may include the user 212. Further, the video may be tampered such that the video depicts the user 212 involved in an unauthorized activity.

In operation, the system 202 may be configured to receive the first vehicle data associated with the vehicle 204 and the user 212. The system 202 may be configured to retrieve second data associated (hereinafter referred to as “second vehicle data”) with the vehicle 204. The second vehicle data may include the sensor data associated with the vehicle 204, the historical driving data associated with the vehicle 204, and multi-dimensional reference data associated with the vehicle 204. In an embodiment, the multi-dimensional reference data may include a three-dimensional (3D) model associated with the vehicle 204. The system 202 may be further configured to extract a set of attributes from the first vehicle data. The set of attributes may be associated with the one or more objects of the first vehicle data.

The system 202 may be further configured to verify the set of attributes based on at least one of dynamic contextual data or the second data. The verification of the set of attributes may include at least one of integrity verification associated with the vehicle 204, route verification of the vehicle 204, or alignment verification associated with the vehicle 204. The system 202 may be further configured to calculate a score for the set of attributes based on the verification of the set of attributes. The system 202 may be further configured to generate a result based on the calculated score. Additionally, the system 202 may be further configured to classify the first vehicle data as one of the authentic data or the tampered data based on the generated result. Further, the system 202 may be configured to render the classification of the first vehicle data on any device.

FIG. 3A is a diagram that illustrates an exemplary framework 300 for the verification and validation of the vehicle data, in accordance with an embodiment of the disclosure. FIG. 3A is explained in conjunction with elements from FIG. 1 and FIG. 2. The framework 300 includes operations for input reception 302, integrity verification 304, route verification 306, consistency verification 308, and alignment verification 310. Additional or fewer operations than the ones shown in FIG. 3 may also be possible within the scope of this disclosure. The framework 300 may be executed as a workflow by the system 202 of FIG. 3 on demand or automatically when the vehicle data (e.g., the first vehicle data) is made available for verification. The system 202 may execute each operation of the framework 300 in an organized sequence for conducting the verification and validation of the vehicle data.

The framework 300 for the verification and validation of the vehicle data includes an operation for the input reception 302. In an embodiment, in the input reception 302, the system 202 may be configured to receive the first vehicle data associated with the vehicle 204. The system 202 may receive the first vehicle data from one or more sources such as the database 208, external data sources, and the like. The first vehicle data may correspond to one of the authentic data or the tampered data. Examples of the authentic data may correspond to data associated with the one or more sensors of the vehicle 204 such as video data, audio data, GPS data, and the like. Examples of the tampered data may include deep fake video data, tampered audio data, and the like. In an embodiment, the first vehicle data is associated with the vehicle 204 (or the one or more sensors of the vehicle 204) such that the first vehicle data may be generated by tampering or modifying data from the vehicle 204. For example, actual data from the vehicle may be tampered to indicate that the vehicle 204 was driven at a speed higher than the actual speed of the vehicle 204.

In an embodiment, the first vehicle data (e.g., the audio data or the video data) may be intentionally altered or fabricated to falsely accuse the user 212 of various actions that the user 212 may not have committed such as reckless driving, violating traffic laws, committing a crime, and the like. The first vehicle data may be intentionally altered or fabricated by a malicious actor such as a hacker or an attacker. Thus, the system 202 may receive the first vehicle data from the law enforcement authorities to verify the authenticity of the first vehicle data.

In additional embodiments, the first vehicle data may be generated by the user 212 such that the first vehicle data may be altered to depict a fabricated accident or exaggerate damages to claim compensation fraudulently. Thus, the system 202 may receive the first vehicle data from an insurance company associated with the user 212 to verify the authenticity of the first vehicle data prior to approving or contesting an insurance claim.

In yet additional embodiments, the first vehicle data may be publicly available without the user 212 uploading the first vehicle data, thereby raising concerns about potential privacy breaches. Thus, the system 202 may receive the first vehicle data from the user 212 to verify whether data associated with the user 212 was leaked or if the data (e.g., the first vehicle data) is a fabricated or tampered video. Thus, the system 202 may provide the user 212 with means to cross-check whether the origin of the data involves a breach from the vehicle manufacturer or whether the data was manipulated.

The framework 300 for the verification and validation of the vehicle data includes an operation for the integrity verification 304. In an embodiment, in the integrity verification 304, the system 202 may be configured to retrieve the second vehicle data associated with the vehicle 204. The system 202 may be further configured to apply the ML model 206 on the first vehicle data to extract a first set of attributes from the first vehicle data. The first set of attributes may be associated with the one or more objects present in the first vehicle data. The first vehicle data may correspond to the set of image frames associated with the vehicle 204. Further, the one or more objects may correspond to visual elements or entities captured in the set of image frames such as the passengers (e.g., the user 212) present in the vehicle 204, items (e.g., mobile devices, bags, seatbelts, seat cushions, dashboard figurines, and the like) present in the vehicle 204, road signs, buildings, and additional environmental features visible within the image frames.

In an embodiment, the first set of attributes may include at least one of a light source associated with the one or more objects, shadows associated with the one or more objects, interactions associated with the one or more objects, and the like. The system 202 may be further configured to verify the integrity of the first set of attributes based on the dynamic contextual data. The dynamic contextual data may include environmental factors associated with the vehicle. The environmental factors may correspond to reference parameters that may represent expected environmental behavior during vehicle operation. The environmental factors may be utilized as a contextual baseline to verify the integrity of the first vehicle data (e.g., the first set of attributes) to assess whether the first vehicle data aligns with real-world conditions. In an embodiment, the environmental factors may correspond to at least one of data associated with principles of light, shadow dynamics data, object interaction data, or human motion dynamics data. Further, the verification of the integrity of the first set of attributes includes physics based verification, and biometric verification.

In an embodiment, the principles of light may refer to physical laws governing the behavior of light, including properties like intensity, reflection, refraction, diffusion, and scattering, in relation to the one or more objects in a scene. For example, the principles of light may be used to verify whether illumination within the vehicle 204 aligns with natural or expected sources of light. The shadow dynamics data may refer to the behavior and characteristics of shadows in a visual scene (e.g., the set of image frames), including direction of the shadows, length of the shadows, intensity of the shadows, and shape of the shadows, as influenced by the position of a light source and the one or more objects. This may serve as reference data for evaluating whether shadows associated with the one or more objects in the first vehicle data are identical to the expected environmental and temporal context, such as the position of the sun or artificial light sources.

The object interaction data may refer to standards describing the spatial and physical interactions of objects within a scene. This includes data on collisions, contact points, and relative motions expected under real-world conditions and may be used for evaluating whether interactions associated with the one or more objects in the first vehicle data are natural or contextually valid. The human motion dynamics data may refer to data related to the natural movement patterns of humans, including how the humans walk, run, or interact with the surrounding environment. This data may include aspects such as posture changes, continuity of movement, and the like, and may be used for evaluating whether human movement detected in the first vehicle data is natural or identical to normal human behavior.

In additional embodiments, the first set of attributes may include first metadata associated with the set of image frames. By way of example, and not by limitation, the first metadata may include Exchangeable image file format (EXIF) protocol that may provide details about a source of the set of image frames, and a first type of encoding associated with the set of image frames such as specific video compression standards (e.g., H.264 and H.265) that may define how the set of image frames is formatted. Additionally, the sensor data may include second metadata associated with the vehicle. By way of example, and not by limitation, second metadata may include preconfigured information related to standard formats and encodings protocols such as the type of camera used (e.g., resolution, supported EXIF field), and standard compression standard used in the vehicle 204. The system 202 may be further configured to verify the integrity of the first set of attributes based on the sensor data. The verification of the integrity of the first set of attributes may be based on at least one of the dynamic contextual data or the sensor data. Details about the integrity verification 304 are provided, for example, in FIG. 3B.

The framework 300 for the verification and validation of the vehicle data includes an operation for the route verification 306. In an embodiment, in the route verification 306, the system 202 may be further configured to extract a second set of attributes from the first vehicle data. The second set of attributes may correspond to first location metadata associated with the first vehicle data (e.g., the audio data or the video data). By way of example, and not by limitation, the first location metadata may include GPS coordinates (latitude and longitude) of the vehicle 204 when the first vehicle data was captured, geotags within the first vehicle data to further provide detailed location information of the vehicle 204 when the first vehicle data was captured, timestamp indicating exact time when the first vehicle data was captured, and the like. Additionally, the second set of attributes may further correspond to environmental context associated with the first vehicle data such as specific type of terrain, or ambient sound such as traffic noise, wind noise, birds chirping, and the like. The system 202 may identify the type of environment where the vehicle 204 was driven based on the environmental context. For example, when the first vehicle data may include the sound of heavy traffic or honking horns, the first vehicle data may imply that the vehicle 204 is in an urban area. Alternatively, when the first vehicle data may include sounds like birds chirping or water flowing, the first vehicle data may imply that the vehicle 204 is in a rural area or a forest area.

In an embodiment, the timestamp (e.g., the first location metadata) indicates that the first vehicle data was captured at a first time period. Further, the system 202 may be configured to retrieve the sensor data (from the second vehicle data) associated with the vehicle 204 such that the sensor data was captured at the first time period. For example, the system 202 may retrieve the sensor data from a GPS sensor of the set of sensors of the vehicle 204 such that the sensor data may correspond to GPS data recorded by the GPS sensor at the first time period. The system 202 may be further configured to execute the route verification 306 on the second set of attributes based on the sensor data associated with the set of sensors of the vehicle 204. Details about the route verification 306 are provided, for example, in FIG. 3C.

The framework 300 for the verification and validation of the vehicle data includes an operation for the consistency verification 308. In an embodiment, in the consistency verification 308, the system 202 may be configured to retrieve the second vehicle data associated with the vehicle 204. The second vehicle data may correspond to the historical driving data associated with the vehicle 204. The historical driving data may include records of locations where the vehicle 204 was previously driven, timestamps corresponding to specific trips associated with the vehicle 204, environmental conditions (e.g., weather data such as temperature, precipitation, wind speed, and the like) during the specific trips, and surrounding geographical features (e.g., buildings, vegetation, landmarks, landforms, and the like).

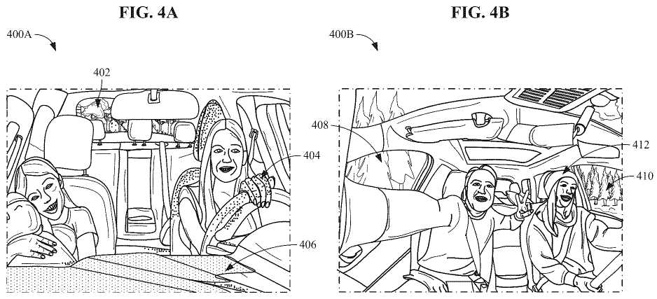

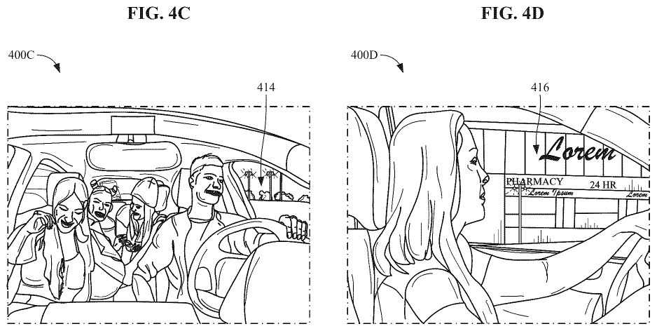

The system 202 may be further configured to apply the ML model 206 on the first vehicle data to extract a third set of attributes from the first vehicle data. The third set of attributes may correspond to at least one of geographical indicators associated with the vehicle 204, environmental indicators associated with the vehicle 204, infrastructural indicators associated with the vehicle 204, atmospheric indicators associated with the vehicle 204, or human activity indicators associated with the vehicle 204. The system 202 may be further configured to verify similarity (e.g., consistency) of the third set of attributes with the historical driving data. In an embodiment, the system 202 may verify whether the third set of attributes of the first vehicle data is identical (e.g., consistent) with the historical driving data of the second vehicle data. For example, when the third set of attributes corresponds to a scene with dense traffic, tall skyscrapers, and rainy weather, the system 202 may cross-reference this information with the historical driving data to confirm whether such conditions align with location, timestamp, and weather data previously associated with the vehicle 204 to verify whether the third set of attributes is associated with the historical driving data. In an embodiment, the system 202 may be further configured to determine a match between the third set of attributes and the historical driving data, such that the match between the third set of attributes and the historical driving data more than 90% indicates high similarity, the match between the third set of attributes and the historical driving data between 65% to 90% indicates moderate similarity, and the match between the third set of attributes and the historical driving data below 65% indicates low similarity (e.g., inconsistency). Details about the consistency verification 308 are provided, for example, in FIG. 3D, FIG. 4A, FIG. 4B, FIG. 4C, and FIG. 4D.

The framework 300 for the verification and validation of the vehicle data includes an operation for alignment verification 310. In an embodiment, in the alignment verification 310, the system 202 may be configured to receive the multi-dimensional reference data associated with the vehicle 204. The multi-dimensional reference data may include the three-dimensional model associated with the vehicle 204. In an embodiment, the three-dimensional model may include vehicle interior and hardware configuration settings that may be provided by the original equipment manufacturer (OEM) or the vehicle manufacturer. The system 202 may be further configured to determine a first field of view associated with the vehicle 204 based on the multi-dimensional reference data.

In an embodiment, the first field of view may correspond to a spatial and visual representation of the vehicle 204 that may be determined based on the second vehicle data (e.g., the multi-dimensional reference data). The first field of view may represent a first perspective of the vehicle 204 (e.g., interior of the vehicle 204) from an image sensor of the set of sensors. In alternate words, the first field of view may include the first perspective that may be in the field of view of the image sensor. Further, the first field of view may serve as a reference point for comparing visual or spatial data in the alignment verification 310.

The system 202 may be further configured to apply the ML model 206 on the first vehicle data to extract a fourth set of attributes from the first vehicle data. The fourth set of attributes may correspond to availability of the one or more objects, spatial relations associated with the one or more objects, or orientation associated with the one or more objects. The one or more objects may correspond to various vehicle components that may be available in the first vehicle data (e.g., the video data). Examples of the one or more objects may include a steering wheel, switches, windows, a seat structure, door panels, and the like. The system 202 may be further configured to determine a second field of view associated with the vehicle 204 based on the fourth set of attributes.

In an embodiment, the second field of view may correspond to a spatial and visual representation of the vehicle 204 that may be determined based on the first vehicle data. The second field of view may represent a second perspective of the vehicle 204 (e.g., interior of the vehicle 204) that may or may not be from the image sensor. The second field of view may serve as a dynamic representation of the vehicle 204 (e.g., the interior of the vehicle 204). Further, the first field of view may be used for comparison with the second field of view to identify inconsistencies, or misalignments indicating potential tampering of the first vehicle data.

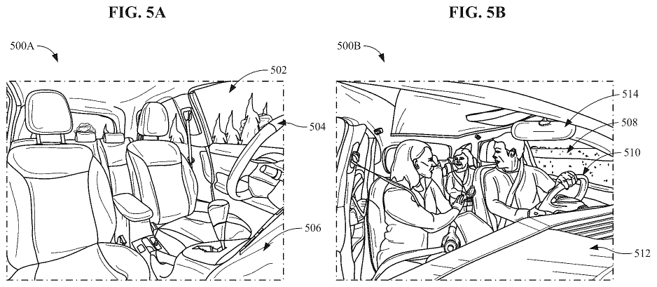

The system 202 may be further configured to verify an alignment factor associated with an alignment between the first field of view and the second field of view. The alignment between the first field of view and the second field of view may correspond to uniformity between the first field of view and the second field of view. In an embodiment, the alignment factor may correspond to a quantifiable parameter that may be used to evaluate the uniformity between the first field of view and the second field of view. The alignment factor may represent a degree to which the spatial arrangements, orientations, and relative positions of the one or more objects match between the first field of view and the second field of view. Details about the alignment verification 310 are provided, for example, in FIG. 3E, FIG. 5A, and FIG. 5B.

The system 202 may be further configured to calculate the score for the fourth set of attributes based on the verification of the fourth set of attributes. The system 202 may be further configured to generate the result based on the calculated score. Additionally, the system 202 may be further configured to classify the first vehicle data as one of the authentic data or the tampered data based on the generated result. Further, the system 202 may be configured to render the classification of the first vehicle data on any device (e.g., a user device associated with the user 212). By way of example, and not by limitation, the rendering of the classification of the first vehicle data may include a detailed breakdown of the classification, such as the calculated score, the detected anomalies, and additional information supporting the classification decision, thereby ensuring clarity of the classification. In an embodiment, the system 202 may be further configured to calculate the score for the first vehicle data (e.g., the first set of attributes, the second set of attributes, the third set of attributes, and the fourth set of attributes) based on each of the integrity verification 304, the route verification 306, the consistency verification 308, and the alignment verification 310 collectively. Thus, the system 202 utilizes a multi-layered approach that ensures improved reliability and accuracy for the verification of the first vehicle data. The reliability and accuracy of the system 202 are improved by cross-referencing multiple data points such as the sensor data, the historical driving data, and the multi-dimensional reference data associated with the vehicle 204 and ensuring that discrepancies are flagged and evaluated from different angles.

In additional embodiments, the system 202 may be further configured to calculate the score for the first vehicle data based on at least one of the integrity verification 304, the route verification 306, the consistency verification 308, and the alignment verification 310. The choice of the verification operation may be based on various types of the first vehicle data. For example, when the first vehicle data corresponds to only the audio data associated with the vehicle, the system 202 may classify the first vehicle data as one of the authentic data or the tampered data based on the route verification 306. This modular verification approach may reduce processing overheads by allowing the system 202 to skip verification operations that may not be needed when sufficient data may be available from the single verification operation. For example, when the match between the third set of attributes and the historical driving data may be below 65%, indicating inconsistencies in the first vehicle data (e.g., the set of image frames) based on the consistency verification 308, the system 202 may skip further verification operations (such as the alignment verification 310) to save computational resources and time. Further, by combining various verification techniques, the system 202 enhances the depth of the verification process, thereby reducing the risk of overlooked manipulations and false positives.

In an embodiment, the system 202 may be further configured to receive feedback based on the classification of the first vehicle data. The feedback may include information on the accuracy of the classification, such as instances of false positives or false negatives, that may be used to train the system 202. The system 202 may be further configured to determine trends in feedback to identify areas where specific verification operations may need improvement, such as including additional parameters for the consistency verification 308. This iterative training process allows the system 202 to improve the precision and reliability of the verification and classification.

FIG. 3B is a diagram that illustrates exemplary operations for the integrity verification 304 of the vehicle data, in accordance with an embodiment of the disclosure. FIG. 3B is explained in conjunction with elements from FIG. 1, FIG. 2, and FIG. 3A. With reference to FIG. 3B, there is shown a first block diagram that illustrates exemplary operations for the integrity verification 304 from 312 to 320, as described herein. The exemplary operations illustrated in the first block diagram may start at 312 and may be performed by any computing system, apparatus, or device, such as by the computer 102 of FIG. 1 or system 202 of FIG. 2. Although illustrated with discrete blocks, the exemplary operations associated with one or more blocks of the first block diagram may be divided into additional blocks, combined into fewer blocks, or eliminated, depending on the particular implementation.

The integrity verification 304, as described herein, refers to a computer-implemented process for validating the integrity and reliability of the first vehicle data, specifically the first set of attributes associated with the one or more objects of the first vehicle data. The integrity verification 304 may include validating whether the first vehicle data aligns with expected physical, contextual, and metadata parameters to detect potential tampering or anomalies. The integrity verification 304 may include various operations such as input filtration 312, physics-based verification 314, metadata verification 316, biometric verification 318, and multimodal verification 320.

The integrity verification 304 includes an operation for input filtration 312. In an embodiment, in the input filtration 312, the system 202 may be configured to rate the first vehicle data based on various factors such as clarity, sharpness, compression quality, resolution, and the like. Based on the ratings of the first vehicle data, the system 202 may be further configured to filter the first vehicle data to remove any data from the first vehicle data that falls below a predetermined threshold rating for further verification. The filtration of the first vehicle data ensures that high-quality data may be retained for further verification. Thus, by rating the first vehicle data and filtering the first vehicle data, the system 202 may ensure that the first vehicle data meets quality standards. For example, when the first vehicle data may correspond to a video recording (e.g., the video data) with a total duration of twenty minutes, and certain segments totaling five minutes are of low quality that may be characterized by issues such as blurred images or pixelation due to low-light conditions, the system 202 may filter out low-quality segments of the video recording. As a result, a new duration of the video recording may be adjusted to fifteen minutes, including a high-quality segment of the video recording that may be suitable for further verification.

The system 202 may be further configured to filter the first vehicle data based on the rating of the first vehicle data, such that data with ratings below the predetermined threshold rating may not be used for further verification. Thus, by rating, the system 202 may ensure that the first vehicle data includes data with quality above the threshold level that may not impede the capability of the system 202 to detect discrepancies in the first vehicle data. Although it is mentioned that the system 202 may filter the first vehicle data to exclude the data with ratings below the predetermined threshold rating, in various embodiments, the system 202 may apply the ML model 206 to reduce noise or upscale a resolution of the data that was below the threshold level.

The integrity verification 304 further includes an operation for physics-based verification 314. In an embodiment, in physics-based verification 314, the system 202 may be further configured to apply the ML model 206 on the first vehicle data to extract a fifth set of attributes from the first vehicle data. The fifth set of attributes may be associated with the one or more objects present in the first vehicle data. The first vehicle data may correspond to the set of image frames associated with the vehicle 204. Further, the one or more objects may correspond to visual elements or entities captured in the set of image frames such as the passengers (e.g., the user 212) present in the vehicle 204, objects (e.g., mobile devices, bags, seatbelts, seat cushions, dashboard figurines, and the like) present in the vehicle 204, road signs, buildings, and additional environmental features visible within the video data captured from the vehicle, and the like.

In an embodiment, physics-based verification 314 as described herein, refers to a computer-implemented process for validating the authenticity of the first vehicle data, specifically the fifth set of attributes associated with the one or more objects of the first vehicle data. Physics-based verification 314 may include determining whether the fifth set of attributes may adhere to established physical principles. This includes evaluating factors such as light behavior, shadow projections, object dynamics, and the like, to determine whether the fifth set of attributes aligns with real-world physical laws.

The fifth set of attributes may include at least one of the light sources associated with the one or more objects (e.g., cabin light within the vehicle 204 or external light sources), shadows associated with the one or more objects, interactions associated with the one or more objects, and the like. The system 202 may be further configured to verify the integrity of the fifth set of attributes based on the dynamic contextual data. The dynamic contextual data may correspond to at least one of the data associated with the principles of light, shadow dynamics data, the object interaction data, or the human motion dynamics data.

In an embodiment, the fifth set of attributes may correspond to a light source associated with the one or more objects. Based on the extraction of the fifth set of attributes, the system 202 may determine how light exposure may influence appearances of the one or more objects. For example, when the first vehicle data suggests that the vehicle 204 may be in motion during nighttime with cabin lights turned on, a first object of the one or more objects that may be closer to the cabin light should exhibit sharper contrast and better details compared to a second object of the one or more objects that may be further way from the cabin light. Thus, if system 202 detects identical contrast and details among the first object and the second object, the system 202 may be further configured to flag the fifth set of attributes (e.g., the first vehicle data) as incorrect.

In an embodiment, the fifth set of attributes may correspond to shadows associated with the one or more objects. Based on the extraction of the fifth set of attributes, the system 202 may determine whether shadows cast by the one or more objects are associated with a position of the light source. For example, when the first vehicle data suggests that the vehicle 204 may be in motion, the shadows may change dynamically in response to movement of the vehicle 204 and a position of the sun. Thus, if system 202 detects that shadows of the one or more objects may not move as expected or the shadows that may remain static despite the movement of the vehicle 204 or the one or more objects, the system 202 may be further configured to flag the fifth set of attributes (e.g., the first vehicle data) as incorrect.

In additional embodiments, the fifth set of attributes may correspond to interactions associated with the one or more objects. The interactions associated with the one or more objects may correspond to relationships or influences between the one or more objects such as spatial relationships, proximity, or dependency. Based on the extraction of the fifth set of attributes, the system 202 may whether the one or more objects react similarly to various conditions within the vehicle 204. For example, when a suspended object such as a hanging air freshener sways backward indicating that the vehicle 204 may be accelerating, the passengers inside the vehicle 204 should also exhibit corresponding physical reactions, such as leaning slightly backward or gripping a support for balance. Alternatively, when the suspended object sways forward indicating that the vehicle 204 may be braking, the passengers inside the vehicle 204 should also exhibit corresponding physical reactions, such as lean forward or exhibit additional natural response. Thus, if system 202 detects a mismatch between the interactions depicted in the first vehicle data and the expected physical behavior, the system 202 may be further configured to flag the fifth set of attributes (e.g., the first vehicle data) as incorrect.

The integrity verification 304 further includes an operation for metadata verification 316. In an embodiment, in the metadata verification 316, the system 202 may be further configured to apply the ML model 206 on the first vehicle data to extract a sixth set of attributes from the first vehicle data. The first vehicle data may correspond to the audio data or the set of image frames associated with the vehicle 204. The sixth set of attributes may include the first metadata associated with the first vehicle data (e.g., the audio data or the set of image frames). By way of example, and not by limitation, the first metadata may include exchangeable image file format (EXIF) protocol data that may provide details about the source of the first vehicle data, and a first type of encoding associated with the first vehicle data such as specific compression standards (e.g., H.264 and H.265) that may define how the first vehicle data is formatted. Additionally, the sensor data may include the second metadata associated with the vehicle 204.

In an embodiment, the second metadata may include preconfigured information related to the standard formats and the encodings protocols such as the type of camera used (e.g., resolution, supported EXIF field), standard compression standard used in the vehicle 204. The system 202 may be further configured to verify the integrity of the sixth set of attributes based on the sensor data. For example, when the first metadata indicates a different resolution of the first vehicle data or a different compression standard of the first vehicle data that deviates from the standard compression standard used in the vehicle 204, the system 202 may flag the first vehicle data potentially as the tampered data.

In an embodiment, the system 202 may be further configured to apply the ML model 206 on the first vehicle data (e.g., the sixth set of attributes) to determine whether the first vehicle data corresponds to the authentic data or the tampered data. By way of example, and not by limitation, the ML model 206 may perform frequency domain processing to detect anomalies in the first vehicle data by examining the frequency distribution of content in the set of image frames. This approach can effectively detect anomalies in images and videos, which are often caused by artifacts of generative models (e.g., high-frequency noise of the generator). Additionally, the ML model 206 may perform a Fourier transform to verify the spectrum of the set of image frames to detect abnormal high-frequency components. Details about the various processes to verify various attributes extracted from the first vehicle data are omitted for the sake of brevity and are known in the art.

The integrity verification 304 further includes an operation for biometric verification 318. In an embodiment, in the biometric verification 318, the system 202 may be further configured to apply the ML model 206 on the first vehicle data to extract a seventh set of attributes from the first vehicle data. The first vehicle data may correspond to the set of image frames associated with the vehicle 204. Further, the one or more objects may correspond to visual elements or entities captured in the set of image frames such as the passengers (e.g., the user 212) present in the vehicle 204.

In an embodiment, the biometric verification 318 as described herein, refers to a computer-implemented process for validating the authenticity of the first vehicle data, specifically the seventh set of attributes associated with the one or more objects of the first vehicle data. The biometric verification 318 may include determining whether human behavioral and physiological attributes observed from the first vehicle data align with natural human behavior patterns.

In an embodiment, the seventh set of attributes may include interactions associated with the one or more objects. By way of example, and not by limitation, the seventh set of attributes may correspond to various movements of passengers of the vehicle 204 such as head turn, eye movement, hand gestures, body shift, eye blink rate, and the like. The system 202 may be further configured to verify the integrity of the seventh set of attributes based on the dynamic contextual data. The dynamic contextual data may correspond to human motion dynamics such as expected behavior in a real-world environment. For example, when the first vehicle data suggests that the eyes of the user 212 remain fixed in one position while head of the user 212 is turned during a conversation, the system 202 may be further configured to flag the seventh set of attributes (e.g., the first vehicle data) as incorrect. Additionally, when the first vehicle data suggests that the eyes of the user 212 are not blinking, while a normal person may blink approximately 15-20 times per minute, the system 202 may be further configured to flag the seventh set of attributes as incorrect.

The integrity verification 304 further includes an operation for the multimodal verification 320. In an embodiment, in the multimodal verification 320, the system 202 may be configured to leverage various tools, libraries, and datasets that may be tailored for the verification (e.g., the multimodal verification 320) of the first vehicle data. Further, the system 202 may determine insights from the first vehicle data that may include multiple data types such as the audio data or the video data. For example, to process the video data (e.g., the set of image frames), the system 202 may use open source computer vision (OpenCV) library to detect irregularities or anomalies within individual frames of the video data. Additionally, to process the audio data, the system 202 may use various advanced speech processing models such as DeepSpeech or waveform to vector (Wav2Vec) to detect anomalies (e.g., pitch variations, speed variations, and the like) in the audio data.

In an embodiment, the system 202 may utilize multimodal transformers, such as visual bidirectional encoder representations from transformers (VisualBERT) or unified language model (UniLM), to correlate features across modalities, enabling deeper insight into relationships between the audio data and the video data. In an embodiment, to train the system 202 for accurate detection, robust datasets such as FaceForencics++, Celeb-DF, or DeeperForensics may be used. Based on the training on the robust datasets, the system 202 may be further configured to verify the integrity of the seventh set of attributes to detect alterations in the first vehicle data that may be indicative of deep-fake attempts.

In additional embodiments, the system 202 may be further configured to utilize third-party deep learning models for the multimodal verification 320. The third-party deep learning models may be pre-trained on various datasets for deepfake detection or anomaly identification and may provide additional verification for the first vehicle data. For example, the third-party deep learning models that may be trained on extensive video data, or the audio data may be used to detect unnatural video artifacts, mismatched audio patterns, or additional anomalies.

FIG. 3C is a diagram that illustrates exemplary operations for the route verification 306 of the vehicle data, in accordance with an embodiment of the disclosure. FIG. 3C is explained in conjunction with elements from FIG. 1, FIG. 2, FIG. 3A, and FIG. 3B. With reference to FIG. 3C, there is shown a second block diagram that illustrates exemplary operations of the route verification 306 from 322 to 334, as described herein. The exemplary operations illustrated in the second block diagram may start at 322 and may be performed by any computing system, apparatus, or device, such as by the computer 102 of FIG. 1 or system 202 of FIG. 2. Although illustrated with discrete blocks, the exemplary operations associated with one or more blocks of the second block diagram may be divided into additional blocks, combined into fewer blocks, or eliminated, depending on the particular implementation.

The route verification 306, as described herein, refers to a computer-implemented process for validating the accuracy and reliability of the first vehicle data, specifically the second set of attributes that may correspond to the first location data of the vehicle. The route verification 306 may include validating whether the first location metadata associated with the first vehicle data aligns with second location metadata associated with the second vehicle data (e.g., the sensor data). By way of example, and not by limitation, the second location metadata may include GPS coordinates (latitude and longitude) of the vehicle 204. The route verification 306 may include various verification processes such as static verification 324 and dynamic verification 326.

The route verification 306 includes an operation for location data retrieval 322. In an embodiment, in the location data retrieval 322, the system 202 may be further configured to apply the ML model 206 on the first vehicle data to extract an eighth set of attributes from the first vehicle data. The eighth set of attributes may be associated with the one or more objects present in the first vehicle data. The eighth set of attributes may correspond to the first location metadata associated with the first vehicle data (e.g., the audio data or the video data). Based on the first location metadata, the system 202 may be further configured to determine the first location of the vehicle 204. In an embodiment, the first location metadata may include GPS coordinates (latitude and longitude) of the vehicle 204 when the first vehicle data was captured, geotags that may provide detailed information about the first location when the first vehicle data was captured, a timestamp indicating exact time when the first vehicle data was captured, and the like. Additionally, the eighth set of attributes may further correspond to an environmental context associated with the first vehicle data such as a specific type of terrain, or ambient sound such as traffic noise or natural background audio.

The system 202 may be configured to identify the first time period from the timestamp (e.g., the first location metadata) associated with the first vehicle data. In an embodiment, based on the first time period, the system 202 may be further configured to retrieve the second vehicle data such that the second vehicle data may include the sensor data. Further, the sensor data may include the second location metadata associated with the first vehicle data (e.g., the audio data or the video data). Based on the sensor data, the system 202 may be further configured to determine the second location of the vehicle 204.

The route verification 306 further includes an operation for the static verification 324. In an embodiment, in the static verification 324, the system 202 may be configured to compare the first location metadata (e.g., the GPS coordinates of the vehicle 204 when the first vehicle data was captured, geotags about the first location when the first vehicle data was captured, and the timestamp indicating exact time when the first vehicle data was captured) with the sensor data (e.g., the GPS data from the set of sensors). In alternate words, the system 202 may compare the first location of the vehicle with the second location. For example, the first location metadata may indicate that the vehicle 204 was in a city center (first location) during the first time period, while the sensor data may indicate that the vehicle 204 was in a suburban area (second location) during the first time period. The system 202 may be further configured to calculate the spatial gap between the first location and the second location. The system 202 may be further configured to determine whether the spatial gap between the first location and the second location is greater than a threshold distance. The system 202 may flag the first vehicle data as potentially tampered data.

In an embodiment, the system 202 may be further configured to determine time intervals between successive geotags to verify alignment with real-world movement. For example, when the first location metadata indicates that the vehicle 204 moved between two locations within a time interval that may indicate that the vehicle 204 should have traveled at five times the speed that may be allowed in a city environment, thus the system 202 may determine that the first location metadata is incorrect indicating potential tampering.

In an embodiment, the static verification 324 as described herein, refers to a computer-implemented process for validating the authenticity of the first vehicle data, specifically the eighth set of attributes associated with the one or more objects of the first vehicle data. The static verification 324 may include comparing the first location metadata and the second location metadata to ensure spatial and temporal attributes of the first location metadata and the second location metadata, such as the GPS coordinates, or timestamps are identical.

The route verification 306 further includes an operation for the dynamic verification 326. In an embodiment, in the dynamic verification 326, the system 202 may be further configured to apply the ML model 206 on the first vehicle data to extract a ninth set of attributes from the first vehicle data. The ninth set of attributes may be associated with the one or more objects present in the first vehicle data. The first vehicle data may include the audio data associated with the vehicle 204 or the video data (e.g., the set of image frames) associated with the vehicle 204. Examples of the one or more objects may include street signs, passing vehicles, roadside elements, terrain, and the like, that may be visible in the video data. The ninth set of attributes associated with the one or more objects may include visual patterns like motion blur, object trajectory, and displacement. Additionally, the ninth set of attributes may further include audio characteristics such as background noise and environmental sound. The system 202 may be further configured to verify the ninth set of attributes with real-world physical expectations derived from the sensor data.

In an embodiment, the system 202 may retrieve the GPS data from the sensor data. Further, the system 202 may use the GPS data to determine whether motion blur in the video data accurately depicts the speed indicated by the GPS data. For example, when the GPS data may indicate that the vehicle 204 was traveling at a speed of 60 miles per hour during the first time period, the system 202 may extract motion blur attributes (e.g., the ninth set of attributes) of stationary objects (e.g., poles, road signs, and the like) that may be visible in the video data. Based on the extraction of the motion blur attributes, the system 202 may evaluate whether an intensity associated with the motion blur attributes may correspond to the speed indicated by the GPS data (e.g., 60 miles per hour) at the first time period. By way of example, and not by limitation, the motion blur with 50% intensity may indicate the speed of 60 miles per hour. Thus, the system 202 may evaluate that the speed indicated by the motion blur attributes and the speed indicated by the GPS data at the first time period are identical. Alternatively, the system 202 may flag the video data (e.g., the first vehicle data) when the intensity associated with the motion blur attributes may indicate slower or faster speed at the first time period compared to the speed indicated by the GPS data at the first time period. Additionally, the system 202 may flag the video data when the GPS data may indicate that the vehicle 204 is in motion but the video data suggests that the background of the video data may be stationary.

In additional embodiments, the system 202 may extract audio features (e.g., the ninth set of attributes) such as wind noise and road noise from the audio data. The wind noise and road noise may be associated with the vehicle 204. Further, the system 202 may retrieve the GPS data from the sensor data. The system 202 may compare the GPS data with the extracted audio features. For example, when the GPS data may indicate that the vehicle 204 was traveling at a speed of 100 miles per hour during the first time period, the system 202 may extract the audio features from the audio data during the first time period. Based on the extraction of the audio features, the system 202 may evaluate whether a noise level associated with the extracted audio features may correspond to the speed indicated by the GPS data (100 miles per hour) at the first time period. The system 202 may flag the audio data (e.g., the first vehicle data) when the extracted audio features may indicate slower or faster speed during the first time period compared to the speed indicated by the GPS data during the first time period. By way of example, and not by limitation, the noise level of 80 decibels (dB) may indicate the speed of 100 miles per hour.

In an embodiment, the dynamic verification 326 as described herein, refers to a computer-implemented process for validating the authenticity of the first vehicle data, specifically the ninth set of attributes associated with the one or more objects of the first vehicle data. The dynamic verification 326 may include comparing dynamic traits (e.g., motion blur, object trajectory, and displacement) associated with the ninth set of attributes with the sensor data to ensure alignment between the dynamic traits and the ninth set of attributes.

The route verification 306 further includes an operation for similarity score determination 328. In an embodiment, in the similarity score operation, the system 202 may calculate a similarity score (e.g., the score) between the first vehicle data (e.g., the eighth set of attributes and the ninth set of attributes) and the sensor data (e.g., the GPS data) based on the application of the ML model 206 on the first vehicle data and the sensor data. The similarity score may be generated based on at least one of the static verification 324 or the dynamic verification 326. The system 202 may use predefined algorithms such as pattern-matching process or a statistical model to evaluate the similarity between the first vehicle data and the sensor data. In an embodiment, the similarity score may range between 0 and 100, and may indicate a match between the first vehicle data and the sensor data. For example, when the GPS data may indicate that the vehicle 204 was traveling at 65 miles per hour, and the intensity associated with the motion blur attributes indicates that the vehicle 204 was travelling at 60 miles per hour, the system 202 may calculate the similarity score as 85 in the range between 0 and 100 indicating 85% match between the first vehicle data and the sensor data. Alternatively, when the GPS data may indicate that the vehicle 204 was traveling at 65 miles per hour, and the intensity associated with the motion blur attributes indicates that the vehicle 204 was traveling at 80 miles per hour, the system 202 may calculate the similarity score as 35 in the range between 0 and 100 indicating 35% match between the first vehicle data and the sensor data.

The route verification 306 further includes an operation 330. In the operation 330, it may be determined that is the similarity score (e.g., the calculated score) greater than a threshold score. The threshold score may correspond to a minimum acceptable level of similarity that may be needed between the first vehicle data and the sensor data to validate the first vehicle data as the authentic data. In an embodiment, the threshold score may establish a benchmark to assess an alignment (or similarity) between the first vehicle data and the sensor data. For example, when the similarity score may range between 0 and 100, the threshold score may correspond to 70. In case the similarity score may be greater than the threshold score, then the control may be transferred to first data validation 332. Alternatively, in case the similarity score may be less than the threshold score, then the control may be transferred to first data invalidation 334.

The route verification 306 further includes an operation for the first data validation 332. In an embodiment, in the first data validation 332, the system 202 may be configured to classify the first vehicle data as the authentic data based on the determination that the similarity score may be greater than the threshold score. Thus, the system 202 may establish the credibility of the first vehicle data based on the route verification 306.

In an embodiment, when the similarity score may be greater than the threshold score but below a first confidence score, the system 202 may proceed with additional verification operations (e.g., the consistency verification 308, or the alignment verification 310). The first confidence score may correspond to a high level of certainty about the authenticity of the first vehicle data and may be higher than the threshold score. For example, when the similarity score corresponds to 85 in the range between 0 and 100 indicating 85% match between the first vehicle data and the sensor data. Further, the threshold score may correspond to 70 and the first confidence score may correspond to 95. Thus, the system 202 may mark the first vehicle data as potentially authentic data, but this may not be conclusive enough for final validation. Therefore, additional verification operations may be performed to confirm the authenticity of the first vehicle data conclusively. Based on the additional verification operations, the system 202 may reduce the risk of errors or manipulations by ensuring that any deviations or discrepancies in the first vehicle data are identified and verified through multiple verification operations, thereby increasing the reliability of the system 202.

The route verification 306 further includes an operation for the first data invalidation 334. In an embodiment, in the first data invalidation 334, the system 202 may be configured to classify the first vehicle data as the tampered data based on the determination that the similarity score may be less than the threshold score. Thus, the system 202 may establish the invalidity of the first vehicle data based on the route verification 306.

In an embodiment, when the similarity score may be less than the threshold score but above a second confidence score, the system 202 may proceed with additional verification operations (e.g., the consistency verification 308, or the alignment verification 310). The second confidence score may correspond to a high level of certainty about tampering of the first vehicle data and may be lower than the threshold score. For example, when the similarity score corresponds to 45 in the range between 0 and 100 indicating a 45% match between the first vehicle data and the sensor data. Further, the threshold score may correspond to 70 and the second confidence score may correspond to 30. Thus, the system 202 may mark the first vehicle data as potentially tampered data, but this may not be conclusive enough for final validation. Therefore, additional verification operations may be performed to confirm tampering of the first vehicle data conclusively. Based on the additional verification operations, the system 202 may reduce the risk of errors or manipulations by ensuring that any deviations or discrepancies in the first vehicle data are identified and verified through multiple verification operations, thereby increasing the reliability of the system 202.

FIG. 3D is a diagram that illustrates exemplary operations for the consistency verification 308 of the vehicle data, in accordance with an embodiment of the disclosure. FIG. 3C is explained in conjunction with elements from FIG. 1, FIG. 2, FIG. 3A, FIG. 3B, and FIG. 3C. With reference to FIG. 3D, there is shown a third block diagram that illustrates exemplary operations for the consistency verification 308 from 336 to 348, as described herein. The exemplary operations illustrated in the third block diagram may start at 336 and may be performed by any computing system, apparatus, or device, such as by the computer 102 of FIG. 1 or system 202 of FIG. 2. Although illustrated with discrete blocks, the exemplary operations associated with one or more blocks of the third block diagram may be divided into additional blocks, combined into fewer blocks, or eliminated, depending on the particular implementation.

The consistency verification 308, as described herein, refers to a computer-implemented process for validating the reliability and similarity of the first vehicle data, specifically the third set of attributes associated with the one or more objects of the first vehicle data. The consistency verification 308 may include validating whether the first vehicle data aligns with the historical driving data associated with the vehicle 204 to detect potential tampering or anomalies.

The consistency verification 308 includes an operation for historical data retrieval 336. In an embodiment, in the historical data retrieval 336, the system 202 may be configured to retrieve the historical driving data associated with the vehicle 204. The historical driving data may include records of locations where the vehicle 204 was previously driven, timestamps corresponding to specific trips associated with the vehicle 204, environmental conditions (e.g., weather data such as temperature, precipitation, wind speed, and the like) during the specific trips, surrounding geographical features (e.g., buildings, vegetation, landmarks, landforms, and the like), and the like.

In an embodiment, the system 202 may be further configured to construct a driving context of the vehicle based on the historical driving data. The driving context may correspond to a dataset that captures environmental factors, road conditions, traffic patterns, driving dynamics, and the like.

The consistency verification 308 further includes an operation for identification 338. In an embodiment, in the identification 338, the system 202 may be further configured to identify one or more identifiers associated with the historical driving data. The one or more identifiers may include route identifiers, environmental identifiers, geographical identifiers, contextual identifiers, and the like. Examples of the route identifiers may include frequently traveled paths, deviation from standard paths, stopping points, and the like. Examples of the environmental identifiers may include surrounding buildings, vegetation type, a landmark visible along the frequently traveled paths, and the like. Examples of the geographical identifiers may include landforms, elevation changes, terrain types, and the like. Examples of the contextual identifiers may include seasonal changes, average weather conditions, light levels during specific periods of the day, and the like.

The system 202 may be further configured to generate a list of the one or more identifiers based on the identification of the one or more identifiers. For example, when the historical driving data may indicate that the vehicle 204 may be frequently driven in a rural area, the list of the one or more identifiers may include farmland, trees, wildlife crossings, and the like. Alternatively, when the historical driving data may indicate that the vehicle 204 may be frequently driven in an urban area, the list of the one or more identifiers may include high-rise buildings, shopping malls, traffic signals, and the like.

The consistency verification 308 further includes an operation for weight assignment 340. In an embodiment, in the weight assignment 340, the system 202 may be configured to assign a set of weights to the one or more identifiers. In an embodiment, the set of weights may be assigned to the one or more identifiers based on various parameters such as uniqueness (or distinctiveness), relevance of the identifiers, proximity with route of the vehicle 204, confidence, and the like. For example, based on the historical driving data a rare building within close proximity to route of the vehicle 204 may be assigned a higher weight compared to weights assigned to common buildings or structures. Additionally, a traffic signal at a specific location that may be identified over time may also be assigned a higher weight than additional identified objects.

The system 202 may be further configured to apply the ML model 206 on the first vehicle data to extract the third set of attributes from the first vehicle data. The third set of attributes may be associated with the one or more objects present in the first vehicle data. The third set of attributes may correspond to at least one of the geographical indicators associated with the vehicle 204, the environmental indicators associated with the vehicle 204, the infrastructural indicators associated with the vehicle 204, the atmospheric indicators associated with the vehicle 204, the human activity indicators associated with the vehicle 204, and the like.

The consistency verification 308 further includes an operation for consistency parameter determination 342. In an embodiment, in the consistency parameter determination 342, the system 202 may be configured to verify the consistency of the third set of attributes based on the one or more identifiers (e.g., the historical driving data). In alternate words, the system 202 may verify whether the third set of attributes is identical with the one or more identifiers. For example, when the third set of attributes corresponds to a scene with dense traffic, tall skyscrapers, and rainy weather, the system 202 may cross-reference this information with the one or more identifiers to confirm whether such conditions align with location, timestamp, and weather data previously associated with the vehicle 204 to verify whether the third set of attributes is identical with the one or more identifiers. Based on the verification of the consistency of the third set of attributes, the system 202 may be further configured to determine a set of ratings associated with the third set of attributes. In an embodiment, the set of ratings may serve as a quantifiable measure of how closely the third set of attributes matches with the one or more identifiers. For example, the set of ratings may be in the range of 0 to 10 such that, the set of ratings between 9 to 10 indicates high confidence in the third set of attributes, the set of ratings between 6 to 9 indicates moderate confidence in the third set of attributes, the set of ratings below 6 indicate low confidence in the third set of attributes.

The system 202 may be further configured to calculate a consistency parameter for the third set of attributes based on the set of weights and the set of ratings. In an embodiment, the consistency parameter may correspond to a product of the set of weights and the third set of attributes as shown in equation 1:

$$consistency parameter = \sum set of weights * set of ratings \qquad ( 1 )$$

The consistency verification 308 further includes an operation 344. In the operation 344, it may be determined that is the consistency parameter greater than a threshold parameter. The threshold parameter may correspond to a minimum acceptable level of similarity that may be needed between the third set of attributes and the one or more identifiers to validate the first vehicle data as the authentic data. In an embodiment, the threshold parameter may establish a benchmark to assess an alignment (or similarity) between the third set of attributes and the one or more identifiers. For example, when the consistency parameter may range between 0 and 100, the threshold parameter may correspond to 70. In case the consistency parameter may be greater than the threshold parameter, then the control may be transferred to second data validation 346. Alternatively, in case the consistency parameter may be less than the threshold parameter, then the control may be transferred to second data invalidation 348.

The consistency verification 308 further includes an operation for the second data validation 346. In an embodiment, in the second data validation 346, the system 202 may be configured to classify the first vehicle data as the authentic data based on the determination that the consistency parameter may be the greater than the threshold parameter. Thus, the system 202 may establish the credibility of the first vehicle data based on the consistency verification 308.

In an embodiment, when the consistency parameter may be the greater than the threshold parameter but below a first confidence parameter, the system 202 may proceed with additional verification operations (e.g., the integrity verification 304, or the alignment verification 310). The first confidence parameter may correspond to a high level of certainty about the authenticity of the first vehicle data and may be higher than the threshold parameter. For example, when the consistency parameter corresponds to 85 in the range between 0 and 100 indicating an 85% match between the third set of attributes and the one or more identifiers. Further, the threshold parameter may correspond to 70 and the first confidence parameter may correspond to 95. Thus, the system 202 may mark the first vehicle data as potentially authentic data, but this may not be conclusive enough for the final validation. Therefore, additional verification operations may be performed to confirm the authenticity of the first vehicle data conclusively. Based on the additional verification operations, the system 202 may reduce the risk of errors or manipulations by ensuring that any deviations or discrepancies in the first vehicle data are identified and verified through multiple verification operations, thereby increasing the reliability of the system 202.

The consistency verification 308 further includes an operation for the second data invalidation 348. In an embodiment, in the second data invalidation 348, the system 202 may be configured to classify the first vehicle data as the tampered data based on the determination that the calculated consistency parameter may be less than the threshold parameter. Thus, the system 202 may establish the invalidity of the first vehicle data based on the consistency verification 308.

In an embodiment, when the consistency parameter may be less than the threshold parameter but above a second confidence parameter, the system 202 may proceed with additional verification operations (e.g., the consistency verification 308, or the alignment verification 310). The second confidence parameter may correspond to a high level of certainty about tampering of the first vehicle data and may be lower than the threshold parameter. For example, when the consistency parameter corresponds to 45 in the range between 0 and 100 indicating a 45% match between the third set of attributes and the one or more identifiers. Further, the threshold parameter may correspond to 70 and the second confidence parameter may correspond to 30. Thus, the system 202 may mark the first vehicle data as potentially tampered data, but this may not be conclusive enough for final validation. Therefore, additional verification operations may be performed to confirm tampering of the first vehicle data conclusively. Based on the additional verification operations, the system 202 may reduce the risk of errors or manipulations by ensuring that any deviations or discrepancies in the first vehicle data are identified and verified through multiple verification operations, thereby increasing the reliability of the system 202.

FIG. 3E is a diagram that illustrates exemplary operations for the alignment verification 310 of the vehicle data, in accordance with an embodiment of the disclosure. FIG. 3C is explained in conjunction with elements from FIG. 1, FIG. 2, FIG. 3A, FIG. 3B, FIGS. 3C, and 3D. With reference to FIG. 3E, there is shown a fourth block diagram that illustrates exemplary operations for the alignment verification 310 from 350 to 362, as described herein. The exemplary operations illustrated in the fourth block diagram may start at 350 and may be performed by any computing system, apparatus, or device, such as by the computer 102 of FIG. 1 or system 202 of FIG. 2. Although illustrated with discrete blocks, the exemplary operations associated with one or more blocks of the fifth block diagram may be divided into additional blocks, combined into fewer blocks, or eliminated, depending on the particular implementation.

The alignment verification 310, as described herein, refers to a computer-implemented process for validating spatial and orientation similarity of the first vehicle data, specifically the fourth set of attributes associated with the one or more objects of the first vehicle data. The alignment verification 310 may include validating whether various parameters (e.g., spatial distances, orientations, object placement, availability, and the like) associated with the one or more objects match with the multi-dimensional reference data.

The alignment verification 310 includes an operation for reference data reception 350. In an embodiment, in the reference data reception 350, the system 202 may be configured to receive the multi-dimensional reference data associated with the vehicle 204. The multi-dimensional reference data may include the three-dimensional model associated with the vehicle 204. In an embodiment, the three-dimensional model may include vehicle interior and hardware configuration settings that may be provided by the OEM or the vehicle manufacturer. Additionally, the multi-dimensional reference data may further include configuration details about an in-vehicle camera of the vehicle 204. The configuration details may include a precise position and an angle at which the in-vehicle camera may be mounted. The configuration details may further include lens specification (aperture, megapixels, and the like) of the in-vehicle camera.

The alignment verification 310 includes an operation for first field of view determination 352. In an embodiment, in the first field of view determination 352, the system 202 may be configured to identify a set of objects associated with the vehicle 204 based on the multi-dimensional reference data. Examples of the set of objects may include the steering wheel, dashboard, switches, control panels, seats, and the like. The multi-dimensional reference data may include a three-dimensional (3D) model associated with the vehicle 204 (e.g., a 3D model of interior of the vehicle 204). Further, the system 202 may be configured to determine the first field of view associated with the vehicle 204 based on the identification of the set of objects from the multi-dimensional reference data.

In an embodiment, the system 202 may be configured to simulate a virtual camera of the vehicle 204 within the 3D model. The virtual camera may be configured to replicate an expected field of view based on OEM specifications that may be included in the 3D model. For example, when the OEM specifications define that a camera of the vehicle 204 (hereinafter referred to as “in-vehicle camera”) may capture an upper-left quadrant of a dashboard of the vehicle 204, front seats, and rear seats. The virtual camera may be adjusted such that the upper-left quadrant of the dashboard, the front seats, and the rear seats are included in the first field of view.

In an embodiment, when the in-vehicle camera may be configured to monitor driver behaviour, the virtual camera may replicate the first field of view that may include the set of objects such as the steering wheel, driver seat, and driver side window. Alternatively, when the in-vehicle camera may be configured to monitor passengers of the vehicle 204, the virtual camera may replicate the first field of view that may include the set of objects such as rear seats, and rear side windows. Thus, the virtual camera may be simulated such that the set of objects may align as per the OEM specification.

The alignment verification 310 includes an operation for second field of view determination 354. In an embodiment, in the second field of view determination 354, the system 202 may be further configured to apply the ML model 206 on the first vehicle data to extract the fourth set of attributes from the first vehicle data. The first vehicle data may include the video data or images associated with the vehicle 204. For example, the video data may capture the interior of the vehicle 204 or surroundings of the vehicle 204. The fourth set of attributes may include at least one of availability of the one or more objects, spatial relations associated with the one or more objects, or orientation associated with the one or more objects.

The one or more objects may correspond to various vehicle components that may be available in the first vehicle data (e.g., the video data). Examples of the one or more objects may include the steering wheel, the switches, the windows, the seat structure, the door panels, and the like. In an embodiment, the system 202 may extract the fourth set of attributes from the first vehicle data that may correspond to spatial relation between front passenger seats and an adjacent arm rest, such as distance or relative positioning. Additionally, the fourth set of attributes that may correspond to the proportion of exterior visible through front windows and rear windows of the vehicle 204. The system 202 may be further configured to determine a second field of view associated with the vehicle 204 based on the fourth set of attributes. For example, the fourth set of attributes may indicate that the camera perspective of the video data may include 20% of the dashboard, 40% of the driver-side window, 20% of rear seats, and 20% of rear windows, thus the system 202 may determine the second field of view based on the fourth set of attributes.

The alignment verification 310 includes an operation for alignment factor determination 356. In an embodiment, in the alignment factor determination 356, the system 202 may be configured to compare the first field of view and the second field of view. The system 202 may be further configured to determine an alignment between the first field of view and the second field of view based on the comparison of the first field of view and the second field of view. The alignment between the first field of view and the second field of view may correspond to uniformity between the first field of view and the second field of view.

In an embodiment, the alignment between the first field of view and the second field of view may correspond to whether the set of objects identified in the first field of view is available in the second field of view in similar orientation and proportion. For example, the first field of view may indicate that the steering wheel occupies 15% of the frame and is centrally aligned with the dashboard, while the driver-side window occupies 20% of the frame. Further, the second field of view may indicate that the steering wheel occupies 15% of the frame and is centrally aligned with the dashboard, while the driver-side window occupies 20% of the frame.

The system 202 may be further configured to calculate an alignment factor based on the comparison of the first field of view and the second field of view. The alignment factor may be associated with the alignment between the first field of view and the second field of view. In alternate words, the alignment factor may represent a quantitative score or percentage indicating a degree of similarity between the first field of view and the second field of view. In an embodiment, the alignment factor may be calculated by aggregating similarity score indicating similarity between the first field of view and the second field of view, spatial relations, and orientations between the set objects identified in the first field of view and the one or more objects available in the second field of view. In an embodiment, a high alignment factor (e.g., 95%) may indicate a strong degree of similarity between the first field of view and the second field of view. Alternatively, a low alignment factor (e.g., 50%) may indicate a low degree of similarity or discrepancies between the first field of view and the second field of view.

The alignment verification 310 further includes an operation 358. In the operation 358 it may be determined that is the alignment factor greater than a threshold factor. The threshold factor may correspond to a minimum acceptable level of alignment that may be needed between the first field of view and the second field of view to validate the first vehicle data as the authentic data. In an embodiment, the threshold factor may establish a benchmark to assess the alignment (or similarity) between the first field of view and the second field of view. For example, when the alignment factor may range between 0 and 100, the threshold factor may correspond to 70. In case the alignment factor may be greater than the threshold factor, then the control may be transferred to 360. Alternatively, in case the alignment factor may be less than the threshold factor, then the control may be transferred to 362.

The alignment verification 310 further includes an operation for third data validation 360. In an embodiment, in the third data validation 360, the system 202 may be configured to classify the first vehicle data as the authentic data based on the determination that the alignment factor may be greater than the threshold factor. Thus, the system 202 may establish the credibility of the first vehicle data based on the alignment verification 310.

In an embodiment, when the alignment factor may be greater than the threshold factor but below a first confidence factor, the system 202 may proceed with additional verification operations (e.g., the integrity verification 304, the route verification 306, or the consistency verification 308). The first confidence factor may correspond to a high level of certainty about the authenticity of the first vehicle data and may be higher than the threshold factor. For example, when the alignment factor corresponds to 85 in the range between 0 and 100 indicating an 85% match between the first field of view and the second field of view. Further, the threshold factor may correspond to 70 and the first confidence parameter may correspond to 95. Thus, the system 202 may mark the first vehicle data as potentially authentic data, but this may not be conclusive enough for the final validation. Therefore, additional verification operations may be performed to confirm the authenticity of the first vehicle data conclusively. Based on the additional verification operations, the system 202 may reduce the risk of errors or manipulations by ensuring that any deviations or discrepancies in the first vehicle data are identified and verified through multiple verification operations, thereby increasing the reliability of the system 202.

The alignment verification 310 further includes an operation for third data invalidation 362. In an embodiment, in the third data invalidation 362, the system 202 may be configured to classify the first vehicle data as the tampered data based on the determination that the alignment factor may be less than the threshold factor. Thus, the system 202 may establish the invalidity of the first vehicle data based on the alignment verification 310.

In an embodiment, when the alignment factor may be less than the threshold factor but above a second confidence parameter, the system 202 may proceed with additional verification operations (e.g., the integrity verification 304, or the consistency verification 308). The second confidence parameter may correspond to a high level of certainty about tampering of the first vehicle data and may be lower than the threshold factor. For example, when the alignment factor corresponds to 45 in the range between 0 and 100 indicating a 45% match between the fourth set of attributes and the one or more identifiers. Further, the threshold factor may correspond to 70 and the second confidence parameter may correspond to 30. Thus, the system 202 may mark the first vehicle data as potentially tampered data, but this may not be conclusive enough for final validation. Therefore, additional verification operations may be performed to confirm tampering of the first vehicle data conclusively. Based on the additional verification operations, the system 202 may reduce the risk of errors or manipulations by ensuring that any deviations or discrepancies in the first vehicle data are identified and verified through multiple verification operations, thereby increasing the reliability of the system 202.

FIG. 4A is a diagram that illustrates a first exemplary scenario for the consistency verification 308, in accordance with an embodiment of the disclosure. FIG. 4A is explained in conjunction with elements from FIG. 1, FIG. 2, and FIG. 3. With reference to FIG. 4A, there is shown an exemplary first snapshot 400A of the interior of the vehicle 204. In an embodiment, the first snapshot 400A may correspond to a first image frame of the set of image frames (e.g., the first vehicle data).

The system 202 may be configured to receive the first snapshot 400A (e.g., the first vehicle data) from one or more sources such as the database 208, external data sources, and the like. The system 202 may be configured to retrieve the historical driving data associated with the vehicle 204. The historical driving data may include records of locations where the vehicle 204 was previously driven, timestamps corresponding to specific trips associated with the vehicle 204, environmental conditions (e.g., weather data such as temperature, precipitation, wind speed, and the like) during the specific trips, surrounding geographical features (e.g., buildings, vegetation, landmarks, landforms, and the like), and the like.

The system 202 may be further configured to generate the driving context based on the historical driving data. Further, the system 202 may be further configured to identify one or more identifiers based on the generated driving context. The one or more identifiers may include route identifiers, environmental identifiers, geographical identifiers, contextual identifiers, and the like. The system 202 may be further configured to assign the set of weights to the one or more identifiers. For the sake of brevity, it is assumed that the system 202 may assign equal weights to each identifier of the one or more identifiers.

In an embodiment, the driving context may suggest that the vehicle 204 was driven through a forest during the daytime with a clear sky. Thus, the system 202 may identify a first identifier of the one or more identifiers as forest vegetation. Further, the system 202 may identify a second identifier of the one or more identifiers as sunny weather. The system 202 may be further configured to apply the ML model 206 on the first snapshot 400A to extract the third set of attributes from the first vehicle data. The third set of attributes may include a first tree 402 in the background indicating forest vegetation. The third set of attributes may further include sunlight exposure 404 and a shadow 406 indicating sunny weather. Further, the system 202 verifies that the third set of attributes is identical with the one or more identifiers based on the similarity between the driving context (e.g., the first identifier and the second identifier) and the third set of attributes. The system 202 may further determine the set of ratings for the third set of attributes. The system 202 may further calculate the consistency parameter for the third set of attributes based on the set of weights and the set of ratings. For example, the set of weights may correspond to 1 and the set of ratings for the third set of attributes may correspond to 9 in the range of 0 to 10 indicating high confidence in the third set of attributes. Further, the consistency parameter may be a product of the set of weights and the third set of attributes, such that the consistency parameter may correspond to 9 in the range of 0 to 10. The system 202 may further generate the result (outcome of the consistency verification 308) based on the calculated consistency parameter, the result may indicate that the first snapshot 400A corresponds to the authentic data.

FIG. 4B is a diagram that illustrates a second exemplary scenario for the consistency verification 308, in accordance with an embodiment of the disclosure. FIG. 4B is explained in conjunction with elements from FIG. 1, FIG. 2, FIG. 3, and FIG. 4A. With reference to FIG. 4B, there is shown an exemplary second snapshot 400B of the interior of the vehicle 204. In an embodiment, the second snapshot 400B may correspond to a second image frame of the set of image frames (e.g., the first vehicle data).

The system 202 may be configured to receive the second snapshot 400B (e.g., the first vehicle data) from one or more sources such as the database 208, external data sources, and the like. The system 202 may be configured to retrieve the historical driving data associated with the vehicle 204.

In an embodiment, the driving context may suggest that the vehicle 204 was driven through a forest during the winter season. Thus, the system 202 may identify the first identifier of the one or more identifiers as forest vegetation. Further, the system 202 may identify the second identifier of the one or more identifiers as cold weather. The system 202 may be further configured to apply the ML model 206 on the second snapshot 400B to extract the third set of attributes from the first vehicle data. The third set of attributes may include a second tree 408 and a third three 410 in the background indicating forest vegetation. The third set of attributes may further include winter cap 412 indicating the cold weather. Thus, the system 202 may verify that the third set of attributes is identical with the one or more identifiers based on the similarity between the driving context (e.g., the first identifier and the second identifier) and the third set of attributes. Further, the system 202 may assign the set of ratings for the third set of attributes as 9.1 in the range of 0 to 10 indicating high confidence in the third set of attributes. Further, the set of weights may correspond to 1. The consistency parameter may be a product of the set of weights and the third set of attributes, such that the consistency parameter may correspond to 9.1 in the range of 0 to 10. Based on the calculated consistency parameter, the system 202 may further generate the result indicating the second snapshot 400B as the authentic data.

FIG. 4C is a diagram that illustrates a third exemplary scenario for the consistency verification 308, in accordance with an embodiment of the disclosure. FIG. 4C is explained in conjunction with elements from FIG. 1, FIG. 2, FIG. 3, FIG. 4A, and FIG. 4B. With reference to FIG. 4C, there is shown an exemplary third snapshot 400C of the interior of the vehicle 204. In an embodiment, the third snapshot 400C may correspond to a third image frame of the set of image frames (e.g., the first vehicle data).

The system 202 may be configured to receive the third snapshot 400C (e.g., the first vehicle data) from one or more sources such as the database 208, external data sources, and the like. The system 202 may be configured to retrieve the historical driving data associated with the vehicle 204.

In an embodiment, the driving context may suggest that the vehicle 204 was driven in a city during late hours. Thus, the system 202 may identify the first identifier of the one or more identifiers as city landscape. Further, the system 202 may identify the second identifier of the one or more identifiers as low light. The system 202 may be further configured to apply the ML model 206 on the third snapshot 400C to extract the third set of attributes from the first vehicle data. The third set of attributes may include a streetlight 414 that is illuminated indicating nighttime. Thus, the system 202 may verify that the third set of attributes is moderately similar to the one or more identifiers based on the similarity between the driving context (e.g., the first identifier and the second identifier) and the third set of attributes. Further, the system 202 may assign the set of ratings for the third set of attributes as 7.5 in the range of 0 to 10 indicating moderate confidence in the third set of attributes. Further, the set of weights may correspond to 1. The consistency parameter may be a product of the set of weights and the third set of attributes, such that the consistency parameter may correspond to 7.5 in the range of 0 to 10. Based on the calculated consistency parameter, the system 202 may further generate the result indicating the third snapshot 400C as the authentic data. Although the first snapshot 400A may be classified as the authentic data, the system 202 may further verify the first vehicle data based on at least one of the integrity verification, the route verification, or the alignment verification.

FIG. 4D is a diagram that illustrates a fourth exemplary scenario for the consistency verification 308, in accordance with an embodiment of the disclosure. FIG. 4D is explained in conjunction with elements from FIG. 1, FIG. 2, FIG. 3, FIG. 4A, FIG. 4B, and FIG. 4C. With reference to FIG. 4D, there is shown an exemplary fourth snapshot 400D of the interior of the vehicle 204. In an embodiment, the fourth snapshot 400D may correspond to a fourth image frame of the set of image frames (e.g., the first vehicle data).

The system 202 may be configured to receive the fourth snapshot 400D (e.g., the first vehicle data) from one or more sources such as the database 208, external data sources, and the like. The system 202 may be configured to retrieve the historical driving data associated with the vehicle 204.

In an embodiment, the driving context may suggest that the vehicle 204 was driven in a city on a specific path that includes a shopping complex. Thus, the system 202 may identify the first identifier of the one or more identifiers as city landscape. Further, the system 202 may identify the second identifier of the one or more identifiers as the pharmacy store. The system 202 may be further configured to apply the ML model 206 on the fourth snapshot 400D to extract the third set of attributes from the first vehicle data. The third set of attributes may include a pharmacy logo 416 that corresponds to the pharmacy store. The system 202 may verify that the third set of attributes is different than the one or more identifiers as the specific path suggested by the driving context does not include a pharmacy store. Thus, the system 202 may assign the set of ratings for the third set of attributes as 0.1 in the range of 0 to 10 indicating low confidence in the third set of attributes. Further, the set of weights may correspond to 1. The consistency parameter may be a product of the set of weights and the third set of attributes, such that the consistency parameter may correspond to 0.1 in the range of 0 to 10. Based on the calculated consistency parameter, the system 202 may further generate the result indicating the fourth snapshot 400D as the tampered data.

FIGS. 5A and 5B are diagrams that illustrate an exemplary scenario for alignment verification 310, in accordance with an embodiment of the disclosure. FIGS. 5A and 5B are explained in conjunction with elements from FIG. 1, FIG. 2, FIG. 3, FIG. 4A, FIG. 4B, FIG. 4C, and FIG. 4D.

With reference to FIG. 5A, there is shown an exemplary fifth snapshot 500A of the interior of the vehicle 204. In an embodiment, the fifth snapshot 500A may correspond to the first field of view. In an embodiment, the system 202 may be configured to receive the multi-dimensional reference data associated with the vehicle 204. The multi-dimensional reference data may include the three-dimensional model associated with the vehicle 204. The system 202 may be configured to identify the set of objects associated with the vehicle 204 based on the multi-dimensional reference data. Examples of the set of objects may include the steering wheel, the dashboard, the switches, the control panels, the seats, and the like. The multi-dimensional reference data may include a three-dimensional (3D) model associated with the vehicle 204 (e.g., the 3D model of interior of the vehicle 204). Further, the system 202 may be configured to determine the first field of view associated with the vehicle 204 based on the identification of the set of objects from the multi-dimensional reference data. The first field of view may include a first driver side window 502, a first steering wheel 504, and a first dashboard segment 506.

With reference to FIG. 5B, there is shown an exemplary sixth snapshot 500B of the interior of the vehicle 204. In an embodiment, the sixth snapshot 500B may correspond to a fifth image frame of the set of image frames (e.g., the first vehicle data). The system 202 may be configured to receive the sixth snapshot 500B (e.g., the first vehicle data) from one or more sources such as the database 208, external data sources, and the like.

The system 202 may be further configured to apply the ML model 206 on the sixth snapshot 500B to extract the fourth set of attributes from the first vehicle data. The fourth set of attributes may include a second driver side window 508, a second steering wheel 510, a second dashboard segment 512, and a rear view mirror 514. The system 202 may be further configured to determine the second field of view associated with the vehicle 204 based on the fourth set of attributes.

The system 202 may be configured to compare the first field of view and the second field of view. Based on the comparison of the first field of view and the second field of view, the system 202 may be further configured to determine that the first field of view may not align with the second field of view. The system 202 may be further configured to calculate the alignment factor based on the alignment of the first field of view and the second field of view. Based on the alignment factor, the system 202 may further generate the result indicating the fifth snapshot 500A as the tampered data.

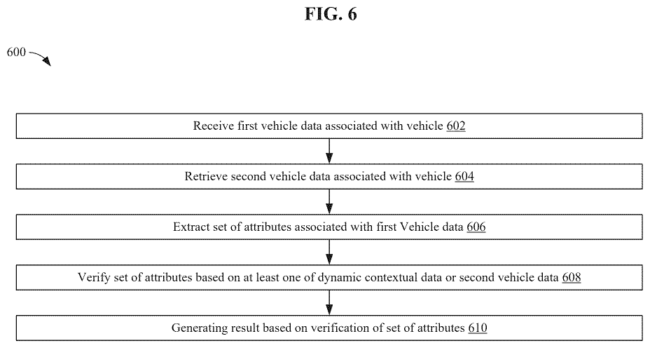

FIG. 6 is a diagram that illustrates a flowchart of an exemplary method for verification and validation of the vehicle data, in accordance with an embodiment of the disclosure. FIG. 6 is explained in conjunction with elements from FIG. 1, FIG. 2, FIG. 3, FIG. 4A, FIG. 4B, FIG. 4C, FIG. 4D, FIG. 5A, and FIG. 5B. With reference to FIG. 6, there is shown a flowchart 600. The operations of the exemplary method may be executed by any computing system, for example, by the computer 102 of FIG. 1 or the system 202 of FIG. 2. The operations of the flowchart 600 may start at 602.

At 602, the first vehicle data associated with the vehicle 204 is received. In an embodiment of the disclosure, the system 202 may be configured to receive the first vehicle data associated with the vehicle 204 from one or more sources (e.g., the database 208, external data sources, and the like). The first vehicle data may correspond to one of the authentic data or the tampered data. Examples of the authentic data may correspond to data associated with the one or more sensors of the vehicle 204 such as video data, audio data, GPS data, and the like. Examples of the tampered data may include deep fake video data, tampered audio data, and the like. Details about the reception of the first vehicle data are provided, for example, in FIG. 2, and FIG. 3A.

At 604, the second vehicle data associated with the vehicle 204 is retrieved. In an embodiment of the disclosure, the system 202 may be configured to retrieve the second vehicle data associated with the vehicle 204. The second data may include the sensor data associated with the vehicle 204, the historical driving data associated with the vehicle 204, and the multi-dimensional reference data associated with the vehicle 204. Details about the retrieval of the second vehicle data are provided, for example, in FIG. 2, and FIG. 3A.

At 606, the set of attributes associated with the first vehicle data is extracted. In an embodiment of the disclosure, the system 202 may be configured to extract the set of attributes from the first vehicle data. The first vehicle data may correspond to at least one of the audio data associated with the vehicle 204 or the set of image frames associated with the vehicle 204. Further, the set of attributes may be associated with the one or more objects (e.g., the passengers present in the vehicle 204, the items present in the vehicle 204, and the like) of the first vehicle data. Details about the extraction of the set of attributes are provided, for example, in FIG. 2, FIG. 3A, FIG. 3B, FIG. 3D, and FIG. 3E.

At 608, the set of attributes is verified based on at least one of the dynamic contextual data or the second vehicle data. In an embodiment of the disclosure, the system 202 may be configured to verify the set of attributes based on at least one of the dynamic contextual data or the second vehicle data. The verification of the set of attributes includes at least one of the integrity verification 304, the route verification 306, the consistency verification 308, or the alignment verification 310. The system 202 may be further configured to classify the first vehicle data as one of the authentic data or the tampered data based on the generated result. Details about the verification of the set of attributes are provided, for example, in FIG. 2, FIG. 3A, FIG. 3B, FIG. 3D, and FIG. 3E.

At 610, the result is generated. In an embodiment of the disclosure, the system 202 may be configured to generate the result based on the verification of the set of attributes. Further, the system 202 may be configured to render the result on any device (e.g., a smartphone, a computer, or the like). Details about the generation of the result are provided, for example, in FIG. 2, and FIG. 3A, FIG. 4A, FIG. 4B, FIG. 4C, FIG. 4D, FIG. 5A, and FIG. 5B.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable a reader of ordinary skill in the art to understand the embodiments disclosed herein.

What is claimed is:

1. A computer-implemented method, comprising:
receiving, by a computer, first data associated with a vehicle, wherein the first data comprises at least one of audio data, or a set of image frames;
retrieving, by the computer, second data associated with the vehicle, wherein the second data comprises sensor data, historical driving data, and multi-dimensional reference data;
extracting, by the computer, a set of attributes from the first data;
verifying, by the computer, the set of attributes based on at least one of dynamic contextual data or the second data, wherein
the verification of the set of attributes comprises at least one of integrity verification associated with the vehicle, route verification of the vehicle, or alignment verification associated with the vehicle, and
the dynamic contextual data comprises environmental factors associated with the vehicle; and
generating, by the computer, a result based on the verification of the set of attributes.

2. The computer-implemented method of claim 1, further comprising:
calculating, by the computer, a score for the set of attributes based on the verification of the set of attributes;
generating, by the computer, the result based on the calculated score for the set of attributes; and
classifying, by the computer, the first data as one of authentic data or tampered data based on the generated result.

3. The computer-implemented method of claim 1, wherein the set of image frames comprises one or more objects.

4. The computer-implemented method of claim 3, wherein the set of attributes comprises at least one of a source of light associated with the one or more objects, shadows associated with the one or more objects, or interactions associated with the one or more objects, and wherein the integrity verification comprises verifying, by the computer, an integrity of the set of attributes based on the dynamic contextual data.

5. The computer-implemented method of claim 4, wherein the verification of the integrity of the set of attributes comprises physics-based verification and biometric verification.

6. The computer-implemented method of claim 3, wherein the set of attributes comprises first metadata associated with the set of image frames, and wherein the integrity verification comprises verifying, by the computer, an integrity of the set of attributes based on the sensor data.

7. The computer-implemented method of claim 6, wherein the sensor data comprises second metadata associated with the vehicle, and wherein the verification of the integrity of the set of attributes comprises metadata verification of the set of attributes and the sensor data.

8. The computer-implemented method of claim 3, wherein the set of attributes comprises at least one of an availability of the one or more objects, spatial relations associated with the one or more objects, or an orientation associated with the one or more objects, and wherein the alignment verification comprises:
determining, by the computer, a first field of view associated with the vehicle based on the multi-dimensional reference data;
determining, by the computer, a second field of view associated with the vehicle based on the set of attributes; and
verifying, by the computer, an alignment factor associated with an alignment between the first field of view and the second field of view.

9. The computer-implemented method of claim 8, wherein the multi-dimensional reference data comprises a three-dimensional model associated with the vehicle.

10. The computer-implemented method of claim 3, wherein
the verification of the set of attributes further comprises consistency verification, and
the set of attributes comprises at least one of geographical indicators, environmental indicators, infrastructural indicators, atmospheric indicators, or human activity indicators, and
wherein the consistency verification comprises verifying, by the computer, a consistency of the set of attributes based on the historical driving data.

11. The computer-implemented method of claim 10, further comprising:
identifying, by the computer, one or more identifiers associated with the historical driving data;
assigning, by the computer, a set of weights to the one or more identifiers;
determining, by the computer, a set of ratings associated with the set of attributes based on the verification of the consistency of the set of attributes;
calculating, by the computer, a consistency parameter for the set of attributes based on the set of weights and the set of ratings; and
generating, by the computer, the result based on the calculated consistency parameter.

12. The computer-implemented method of claim 3, wherein
the set of attributes comprises first location metadata of the vehicle associated with the audio data, or the set of image frames, and
the route verification comprises verifying, by the computer, the first location metadata based on the sensor data associated with a set of sensors of the vehicle, and wherein the sensor data comprises second location metadata of the vehicle.

13. A computer system, comprising:
a processor set;
one or more computer-readable storage media; and
program instructions stored on the one or more computer-readable storage media, the program instructions executable by the processor set to cause the processor set to:
receive first data associated with a vehicle, wherein the first data comprises at least one of audio data, or a set of image frames, and wherein the set of image frames comprises one or more objects;
retrieve second data associated with the vehicle, wherein the second data comprises sensor data, historical driving data, and multi-dimensional reference data;
extract a set of attributes from the first data;
verify the set of attributes based on at least one of dynamic contextual data or the second data, wherein
the verification of the set of attributes comprises at least one of integrity verification associated with the vehicle, route verification of the vehicle, or alignment verification associated with the vehicle, and
the dynamic contextual data comprises environmental factors associated with the vehicle;
calculate a score for the set of attributes based on the verification of the set of attributes; and
generate a result based on the calculated score for the set of attributes.

14. The computer system of claim 13, wherein the program instructions further cause the processor set to classify the first data as one of authentic data or tampered data based on the generated result.

15. The computer system of claim 13, wherein the set of attributes comprises at least one of a source of light associated with the one or more objects, shadows associated with the one or more objects, or interactions associated with the one or more objects, and wherein the program instructions for the integrity verification further cause the processor set to verify an integrity of the set of attributes based on the dynamic contextual data.

16. The computer system of claim 15, wherein the verification of the integrity of the set of attributes comprises physics-based verification, and biometric verification.

17. The computer system of claim 13, wherein the set of attributes comprises first metadata associated with the set of images, and wherein the program instructions for the integrity verification further cause the processor set to verify an integrity of the set of attributes based on the sensor data.

18. The computer system of claim 17, wherein the sensor data comprises second metadata associated with the vehicle, and wherein the verification of the integrity comprises metadata verification of the set of attributes and the sensor data.

19. The computer system of claim 13, wherein the set of attributes comprises at least one of an availability of the one or more objects, spatial relations associated with the one or more objects, or an orientation associated with the one or more objects, the program instructions for the alignment verification further cause the processor set to:
determine a first field of view associated with the vehicle based on the multi-dimensional reference data;
determine a second field of view associated with the vehicle based on the set of attributes; and
verify an alignment factor associated with an alignment between the first field of view and the second field of view.

20. A computer-program product for data verification, the computer-program product comprising:
one or more computer-readable storage media; and
program instructions stored on the one or more computer-readable storage media to perform operations comprising:
receiving first data associated with a vehicle, wherein the first data comprises at least one of audio data, or a set of image frames;
retrieving second data associated with the vehicle, wherein the second data comprises sensor data, historical driving data, and multi-dimensional reference data;
extracting a set of attributes from the first data;
verifying the set of attributes based on at least one of dynamic contextual data or the second data, wherein
the verification of the set of attributes comprises at least one of integrity verification associated with the vehicle, route verification of the vehicle, or alignment verification associated with the vehicle, and
the dynamic contextual data comprises environmental factors associated with the vehicle; and
generating a result based on the verification of the set of attributes.
